(19) United States
(12) Patent Application Publication
(10) Pub. No.: US 2026/0074224 A1
(43) Pub. Date: Mar. 12, 2026

(54) SUPRAMOLECULE AND RECHARGEABLE LITHIUM BATTERIES INCLUDING THE SAME

(71) Applicants: SAMSUNG SDI CO., LTD., Yongin-si, Gyeonggi-do (KR); Research & Business Foundation SUNGKYUNKWAN UNIVERSITY, Suwon-si, Gyeonggi-do (KR)

(72) Inventors: Hyejin KIM, Yongin-si (KR); Piljin YOO, Seoul (KR); Youngugk KIM, Yongin-si (KR); Jaehou NAH, Yongin-si (KR); Minjun KIM, Suwon-si (KR); Jeong-Won HO, Suwon-si (KR); Myeong Gyun NAM, Suwon-si (KR); Janghyeon MOON, Suwon-si (KR)

(21) Appl. No.: 18/806,618

(22) Filed: Aug. 15, 2024

(30) Foreign Application Priority Data
Apr. 9, 2024 (KR) 10-2024-0048219

(51) Int. Cl. H01M 4/62; C08J 3/24; C08K 5/18; C08L 9/06; H01M 4/36; H01M 4/38; H01M 4/587; H01M 10/0525; H01M 10/0565

(52) U.S. Cl. CPC H01M 4/622; C08J 3/246; C08K 5/18; C08L 9/06; H01M 4/364; H01M 4/386; H01M 4/587; H01M 10/0525; H01M 10/0565; C08J 2309/06; C08J 2333/02; C08J 2371/02; C08J 2401/28; C08L 2312/00; H01M 2300/0082

(57) ABSTRACT

A supramolecule and a rechargeable lithium battery including the supramolecule are provided. The supramolecule includes: a polymer having a functional group capable of hydrogen bonding; and an aromatic compound having two or more amine groups, wherein the functional group capable of hydrogen bonding of the polymer and the amine group of the aromatic compound form a hydrogen bond.

### CROSS-REFERENCE TO RELATED APPLICATION

The present application claims priority to and the benefit of Korean Patent Application No. 10-2024-0048219, filed on Apr. 9, 2024, in the Korean Intellectual Property Office, the entire content of which is incorporated herein by reference.

### BACKGROUND

### 1. Field

One or more embodiments of the present disclosure relate to supramolecules and rechargeable lithium batteries including the supramolecules.

### 2. Description of the Related Art

A portable information device, such as a cell phone, a laptop, smart phone, and/or the like, and/or an electric vehicle has used a rechargeable lithium battery having relatively high energy density and easy portability as a driving power source. That is, these devices and/or vehicles typically utilize rechargeable lithium batteries, which are desired for their high energy density and portability, as their power sources. Recently, research has surged or been actively conducted to use a rechargeable lithium battery with high energy density as a driving power source for hybrid or electric vehicles or as a power storage power source for energy storage systems (ESSs) or power walls.

In order to implement rechargeable lithium batteries suitable for these purposes, one or more suitable binders and electrolytes are being examined. For example, various suitable polymers are predominantly or mainly used as binders and electrolytes, but there is still a request and desire (e.g., ongoing demand) to develop (e.g., engineer) materials that exhibit or demonstrate high or strong adhesive force and possess excellent or suitable structural and mechanical properties in addition to enhanced or improved electrical conductivity.

### SUMMARY

One or more aspects of embodiments of the present disclosure are directed toward a supramolecule that exhibits high adhesive force and excellent or suitable structural and mechanical properties while realizing high electrical and ionic conductivity, and a rechargeable lithium battery using the supramolecule.

Additional aspects will be set forth in part in the description which follows and, in part, will be apparent from the description, or may be learned by practice of the presented embodiments.

According to one or more embodiments of the present disclosure, a supramolecule includes: a polymer having a functional group capable of hydrogen bonding; and an aromatic compound having two or more amine groups, wherein the functional group capable of hydrogen bonding of the polymer and the amine group of the aromatic compound form a hydrogen bond.

In one or more embodiments, a rechargeable lithium battery includes the supramolecule.

In one or more embodiments, a rechargeable lithium battery includes: a positive electrode; a negative electrode; a separator between the positive electrode and the negative electrode; and an electrolyte, wherein at least one of the positive electrode, the negative electrode, the separator, or the electrolyte includes the supramolecule.

In one or more embodiments, a rechargeable lithium battery includes: a positive electrode; a negative electrode; and a solid electrolyte layer between the positive electrode and the negative electrode, wherein at least one of the positive electrode, the negative electrode, —or the solid electrolyte layer includes the supramolecule.

### BRIEF DESCRIPTION OF DRAWINGS

The above and other aspects, features, and advantages of certain embodiments of the present disclosure will be more apparent from the following description taken in conjunction with the accompanying drawings.

FIGS. 1 to 4 are each a cross-sectional view schematically showing a rechargeable lithium battery according to one or more embodiments of the present disclosure.

FIG. 5 is a view showing a process of preparing a supramolecule according to one or more embodiments of the present disclosure.

FIG. 6 is a proton nuclear magnetic resonance spectroscopy (1H-NMR) analysis graph for polyacrylic acid (PAA), polyacrylic acid-p-phenylenediamine (PAA-pPD), PAA-pPD-Li salt, and pPD according to one or more embodiments of the present disclosure.

FIG. 7 is a Fourier-transform infrared spectroscopy (FT-IR) analysis graph for PAA, PAA-pPD, PAA-pPD-Li salt, and pPD according to one or more embodiments of the present disclosure.

FIG. 8 is an X-ray photoelectron spectroscopy (XPS) analysis graph (N 1s spectrum) for PAA-pPD according to one or more embodiments of the present disclosure.

FIG. 9 is an XPS analysis graph (C 1s spectrum) for PAA-pPD according to one or more embodiments of the present disclosure.

FIG. 10 is a graph analyzing a storage coefficient of PAA, a loss coefficient of PAA, a storage coefficient of PAA-pPD, and a loss coefficient of PAA-pPD to evaluate the elastic modulus according to one or more embodiments of the present disclosure.

FIG. 11 is a graph analyzing a storage coefficient of PAA, a loss coefficient of PAA, a storage coefficient of PAA-pPD, and a loss coefficient of PAA-pPD to evaluate self-healing characteristics according to one or more embodiments of the present disclosure.

FIG. 12 is a graph confirming durability by measuring changes in G′ and G″ when repeated stress was applied to PAA and PAA-pPD according to one or more embodiments of the present disclosure.

FIG. 13 is a graph measuring the effect of pPD on mechanical fracture of PAA and PAA-pPD according to one or more embodiments of the present disclosure.

FIG. 14 is a nano-indentation analysis graph for an electrode to which PAA is applied and an electrode to which PAA-pPD is applied according to one or more embodiments of the present disclosure.

FIG. 15 is a graph of electrochemical impedance spectroscopy (EIS) analysis of PEO, PEO-pPD, PAA, and PAA-pPD binders according to one or more embodiments of the present disclosure.

FIG. 16 is a cyclic voltammetry (CV) graph for PAA according to one or more embodiments of the present disclosure.

FIG. 17 is a CV graph for PAA-pPD according to one or more embodiments of the present disclosure.

FIG. 18 is a graph showing the discharge capacity and coulombic efficiency according to the number of cycles of a half-cell including PAA or PAA-pPD according to one or more embodiments of the present disclosure.

FIG. 19 is an enlarged graph showing the coulombic efficiency portion in FIG. 18.

FIG. 20 illustrates a scanning electron microscope (SEM) image of a negative electrode using PAA in a half-cell (left panel) and an SEM image of a negative electrode using PAA-pPD in a half-cell (right panel) according to one or more embodiments of the present disclosure.

FIG. 21 is a graph showing the discharge capacity and coulombic efficiency according to the number of cycles of a half-cell including CMC-SBR or CMC-pPD-SBR according to one or more embodiments of the present disclosure.

FIG. 22 is an enlarged graph showing the coulombic efficiency portion in FIG. 21.

FIG. 23 is a graph showing the discharge capacity and coulombic efficiency according to the number of cycles of the half-cells of Example 1, Example 2, and Comparative Example 2 of the present disclosure.

FIG. 24 is a graph showing the discharge capacity and coulombic efficiency according to the number of cycles of the full-cell according to Example 2 and Comparative Example 2 of the present disclosure.

FIG. 25 is a transmission electron microscopy-energy dispersive spectroscopy (TEM-EDS) image of the negative electrode cross-section of Comparative Example 1 of the present disclosure.

FIG. 26 is a TEM-EDS image of the cross-section of the negative electrode of Example 1 of the present disclosure.

FIG. 27 is a graph observing the chemical changes in the electrodes after the first cycle and after 50 cycles for the half-cells of Example 1 and Comparative Example 1 of the present disclosure using XPS.

FIG. 28 is a graph showing the EIS analysis results for the negative electrode after the first cycle and after 100 cycles for the half-cells of Example 1 and Comparative Example 1 of the present disclosure.

FIG. 29 is a graph showing the results of X-ray diffraction (XRD) analysis of the change in crystal structure of the negative electrode plate as the number of cycles increases for the half-cells of Example 1 and Comparative Example 1 of the present disclosure.

FIG. 30 is a graph showing the discharge capacity according to the number of cycles of the all-solid-state battery cells of Example 3 and Comparative Example 3 and the all-solid-state battery cell of Reference Example 1 of the present disclosure.

FIG. 31 is a graph showing the coulombic efficiency according to the number of cycles of the all-solid-state battery cells of Example 3 and Comparative Example 3 and the all-solid-state battery cell of Reference Example 1 of the present disclosure.

### DETAILED DESCRIPTION

Hereinafter, example embodiments will be described in more detail so that those of ordinary skill in the art may easily implement them. However, the present disclosure may be embodied in many different forms and is not construed as limited to the example embodiments set forth herein.

The terminology used herein is used to describe embodiments only, and is not intended to limit the present disclosure. As used herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

As used herein, “combination thereof” refers to a mixture, a laminate, a composite, a copolymer, an alloy, a blend, a reaction product, and/or the like of the constituents.

Herein, it should be understood that terms such as “comprise(s)/comprising,” “include(s)/including,” or “have (has)/having” are intended to designate the presence of an embodied feature, number, step (e.g., act or task), element, and/or a (e.g., any suitable) combination thereof, but it does not preclude the possibility of the presence or addition of one or more other features, numbers, steps (e.g., acts or tasks), elements, and/or a (e.g., any suitable) combination thereof.

In the drawings, the thickness of layers, films, panels, regions, and/or the like, may be exaggerated for clarity and like reference numerals designate like elements throughout the present disclosure, and duplicative descriptions thereof may not be provided for conciseness. It will be understood that if (e.g., when) an element such as a layer, film, region, or substrate is referred to as being “on” another element, it may be directly on the other element or intervening elements may also be present therebetween. In contrast, if (e.g., when) an element is referred to as being “directly on” another element, there are no intervening elements present.

In addition, “layer” as used herein includes not only a shape or a layer formed on the whole surface if (e.g., when) viewed from a plan view, but also a shape or a layer formed on a partial surface.

In one or more embodiments, the average particle diameter may be measured by a method well suitable to those skilled in the art, for example, may be measured by a particle size analyzer, for example, HORIBA, LA-950 laser particle size analyzer, or may be measured by an optical microscope image such as a transmission electron micrograph or a scanning electron micrograph. In one or more embodiments, it may obtain an average particle diameter value by measuring it using a dynamic light scattering method, performing data analysis, counting the number of particles for each particle size range, and calculating from the data. Unless otherwise defined, the average particle diameter may refer to a diameter (D₅₀) of particles having a cumulative volume of 50 volume % in a particle size distribution. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. As used herein, if (e.g., when) a definition is not otherwise provided, the average particle diameter refers to a diameter (D₅₀) of particles having a cumulative volume of 50 volume % in the particle size distribution that is obtained by measuring the size (diameter or major axis length) of about 20 particles at random in a scanning electron microscope image. In the present disclosure, when particles are spherical, “diameter” indicates an particle diameter or an average particle diameter, and when the particles are non-spherical, the “diameter” indicates a major axis length or an average major axis length.

Herein, “or” is not to be construed as an exclusive meaning, for example, “A or B” is construed to include A, B, A+B, and/or the like. Further, as utilized herein, the term “and/or” includes any and all combinations of one or more of the associated listed items. Expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

As used herein, the term “metal” is interpreted as a concept including ordinary metals, transition metals, and metalloids (semi-metals). And the term “Group” as utilized herein refers to a group of the Periodic Table of Elements according to the 1 to 18 grouping system of the International Union of Pure and Applied Chemistry (“IUPAC”).

In a rechargeable lithium battery, a binder is used to fix an active material on a current collector to form an electrode, and thus strong mechanical/chemical stability of the electrode is desired or required to withstand volume changes or high voltage of the active material during the charging and discharging process. Because the binder exists in a coated form on the surface of the active material, it affects ionic conduction, and as a result, the ionic conductivity of a polymer used as the binder becomes a factor affecting charge/discharge and rate of the rechargeable lithium battery. Ionic conduction within a polymer occurs through the bonding and dissociation of polymer chains and lithium ions, and suitable polymer chain mobility is desired or required for ionic conduction. However, if (e.g., when) a polymer has excellent or suitable mechanical properties, chain mobility may be reduced due to interactions between polymers, and thus ionic conductivity is reduced.

Accordingly, one or more embodiments of the present disclosure provide a supramolecule that may concurrently (e.g., simultaneously) improve the mechanical properties and ionic conductivity of polymers, which are in conflicting relationships such as in a trade-off relationship, and that may concurrently (e.g., simultaneously) serve as a binder and solid electrolyte due to these properties. The supramolecule according to one or more embodiments may be expressed as, for example, an electrolytic binder, a binder electrolyte, and/or the like.

### Supramolecule

In one or more embodiments, a supramolecule includes: a polymer having a functional group capable of hydrogen bonding; and an aromatic compound having two or more amine groups, wherein the functional group capable of hydrogen bonding of the polymer and the amine group of the aromatic compound form a hydrogen bond.

In the polymer having the functional group capable of hydrogen bonding, the functional group capable of hydrogen bonding may be a functional group including one or more (e.g., types (kinds)) selected from the group consisting of oxygen and nitrogen, and may be, for example, one or more (e.g., types (kinds)) selected from among a carboxyl group, a carbonate group, a hydroxyl group, an ether group, an ester group, a carbonyl group, and an amine group. In one or more embodiments, the polymer having the functional group capable of hydrogen bonding may include, for example, polyacrylic acid (PAA), polyethylene oxide (PEO), carboxymethyl cellulose (CMC), polyvinyl alcohol (PVA), polyacrylamide (polyacrylamides), polyN-(2-hydroxypropyl) methacrylamide (HPMA), polyethyleneimine (PEI), polymethylmethacrylate (PMMA), polymethylacrylate (PMA), polyvinylacetate (PVAc), polyethylene glycol (PEG), polypropyleneoxide (PPO), polycarbonate (PC), polyacrylamide (PAA), and/or a (e.g., any suitable) combination thereof. In one or more embodiments, the polymer having the functional group capable of hydrogen bonding may include polyacrylic acid (PAA), polyethylene oxide (PEO), carboxymethyl cellulose (CMC), and/or a (e.g., any suitable) combination thereof.

The polymer having the functional group capable of hydrogen bonding may have a linear structure, a branched structure, a crosslinked structure, or a network structure. In one or more embodiments, the polymer having the functional group capable of hydrogen bonding may have a linear structure. If (e.g., when) the polymer has a linear structure, it is advantageous and suitable to form a crosslinked structure between the polymers through an aromatic ring compound having two or more amine groups, which will be described in more detail later.

In one or more embodiments, the polymer has a weight average molecular weight of about 1,000 g/mol to about 5,000,000 g/mol, for example, about 10,000 g/mol to about 5,000,000 g/mol, about 100,000 g/mol to about 5,000,000 g/mol, or about 1,000,000 g/mol to about 5,000,000 g/mol. In this regard, if (e.g., when) the weight average molecular weight of the polymer satisfies the above range, it may reach a level of physical properties desired or required for the electrode while maintaining mechanical strength and durability if (e.g., when) applied as a binder. The weight average molecular weight of the polymer may be measured by Gel Permeation Chromatography (GPC).

In one or more embodiments, in the aromatic compound having two or more amine groups, each amine group may be substituted at any of the ortho, meta, and para positions of another amine group, for example, may be substituted at the para position of another amine group. In addition, there is no limit to the number of amine groups as long as it is two or more, for example, it may be an aromatic diamine compound with two amine groups or an aromatic triamine compound with three amine groups. Additionally, the number of benzene rings in the aromatic compound is not particularly limited, but may be, for example, 1 to 5, 1 to 3, or 1 to 2.

The aromatic diamine compound may include, for example, paraphenylenediamine (p-phenylenediamine) (pPD), metaphenylenediamine (mPDA), 2,5-diaminotoluene, 2,6-diaminotoluene, 4,4′-diaminobiphenyl, 3,3′-dimethyl-4,4′-diaminobiphenyl, 3,3′-dimethoxy-4,4′-diaminobiphenyl, 2,2-bis(trifluoromethyl)-4,4′-diaminobiphenyl, 3,3′-diaminodiphenylmethane, 4,4′-diaminodiphenylmethane, 2,2-bis-(4-aminophenyl) propane, 3,3′-diaminodiphenylsulfone, 4,4′-diaminodiphenylsulfone, 3,3′-diaminodiphenylsulfide, 4,4′-diaminodiphenylsulfide, 3,3′-diaminodiphenylether, 3,4′-diaminodiphenylether, 4,4′-diaminodiphenylether, 1,5-diaminonaphthalene, 4,4′-diaminodiphenyldiethylsilane, 4,4′-diaminodiphenylsilane, 4,4′-diaminodiphenylethylphosphineoxide, 1,3-bis(3-aminophenoxy)benzene, 1,3-bis(4-aminophenoxy)benzene, 1,4-bis(4-aminophenoxy)benzene, bis [4-(3-aminophenoxy)phenyl]sulfone, bis [4-(4-aminophenoxy)phenyl]sulfone, 2,2-bis [4-(4-aminophenoxy)phenyl]propane, 2,2-bis(3-aminophenyl)-1,1,1,3,3,3-hexafluoropropane, 2,2-bis(4-aminophenyl)-1,1,1,3,3,3-hexafluoropropane, 9,9-bis(4-aminophenyl) fluorene, and/or the like. The aromatic diamine compound may be used alone or mixed.

The aromatic triamine compound may include, for example, 2,4,6-triaminopyrimidine, 1,3,5-triaminobenzene, 1,3,5-tris(4-aminophenyl)benzene, 3,4, 4′-triaminodiphenyl ether, 6-phenylpteridine-2,4,7-triamine, tris(4-aminophenyl) methanol, melamine, 2′,4′,4-triaminobenzanilide, 2,5,6-triamino-3-methylpyrimidin-4 (3H)-one, 1,4,5,8-tetraaminoanthraquinone, 3,3′-diaminobenzidine, and/or the like. The aromatic triamine compound may be used alone or mixed. Additionally, the aromatic diamine compound and the aromatic triamine compound may be mixed and used. In one or more embodiments, the aromatic compound having two or more amine groups may be paraphenylenediamine (pPD) selected from among the aromatic diamine compound and aromatic triamine compound.

The aromatic compound having two or more amine groups forms a hydrogen bond with a functional group capable of hydrogen bonding included in the aforementioned polymer, thereby improving adhesion as a binder and forming a selectively permeable film of lithium ions on the surface of the active material. Because the production of lithium compounds synthesized through the reaction of electrolyte solution and lithium ions is suppressed or reduced, even if the temperature inside the battery rises due to a short circuit, there are few thermally unstable lithium compounds, so that decomposition heat generation may be suppressed or reduced and the reaction between the lithium ions in the active material and the electrolyte solution may be suppressed or reduced. In addition, the aromatic compound having two or more amine groups enables ionic conduction between chains by causing ion hopping to vacancy sites, which is the ionic conduction mechanism of a solid electrolyte, within the polymer. In addition, by including aromatic rings in the supramolecule due to the aromatic compound, the supramolecule may realize high mechanical strength and elastic force. In summary, the aromatic compound with the multiple amine groups of the present disclosure enhances the polymer's adhesion and forms a lithium-ion permeable film, reducing the production of unstable lithium compounds and suppressing heat generation, while also facilitating ionic conduction and improving the polymer's mechanical strength and elasticity.

In the supramolecule according to one or more embodiments, the functional group capable of hydrogen bonding of the polymer and the amine group of the aromatic compound may form a hydrogen bond.

The supramolecule is crosslinked by hydrogen bonding between the functional group capable of hydrogen bonding of the main chain polymer and the side chain amine group of the aromatic compound, and the hydrogen bond may exhibit strong bonding force and rapid reversibility. The supramolecule forms a polymer network with a mesh structure due to strong hydrogen bonds between the main chain and the side chains, and if (e.g., when) applied as a polymer binder, it can prevent or reduce rapid volume expansion of the active material and have excellent or suitable adhesive properties. In addition, the supramolecule includes a large number of functional groups and amine groups capable of hydrogen bonding, so that it can form a hydrogen bond with the surface of the active material, which has the advantage of excellent or suitable adhesive properties. In particular, the supramolecule may have high bonding force and stability due to bonding through chemical interaction rather than non-covalent bonding through physical interaction, and has excellent or suitable mechanical properties and self-healing ability, making it possible to continuously restore the electrode structure that has collapsed due to changes in the volume of the active material.

The supramolecule may have a weight average molecular weight of about 10,000 g/mol to about 10,000,000 g/mol, for example, about 100,000 g/mol to about 10,000,000 g/mol, or about 1,000,000 g/mol to about 10,000,000 g/mol. In this regard, if the weight average molecular weight of the supramolecule satisfies the above range(s), the physical properties desired or required for the electrode may be satisfied while maintaining mechanical strength and durability if (e.g., when) applied as a binder.

In one or more embodiments, the supramolecule may further include lithium ions. For example, in one or more embodiments, the supramolecule may be a lithium ion-doped supramolecule. When a crosslinked structure is formed by hydrogen bonding, problems and issues such as reduced chain mobility and reduced ionic conductivity may occur due to the crosslinked structure. However, because the supramolecule includes a hydrogen-accepting functional group, it may have nucleophilic properties capable of attracting lithium ions through a coordination bond, and because it further includes lithium ions, ionic conductivity may be improved by the benzenoid-quinoid transition of an aromatic compound having two or more amine groups. That is, the supramolecule can be doped with lithium ions in a simple way, and the lithium ion-doped supramolecule may realize excellent or suitable lithium ionic conductivity. These lithium ion-doped supramolecular materials may effectively serve as a solid electrolyte as well as a binder in a battery.

In the aromatic compound having two or more amine groups, lithium ions may be conducted from the amine group to the aromatic ring, may be conducted to adjacent carbons within the aromatic ring, and may be conducted from the aromatic ring to the amine group. As such, the activation energy when lithium ions are conducted in the aromatic compound is relatively low, and thus it can effectively serve as an electrolyte that conducts lithium ions. In one or more embodiments, the activation energy of the reaction in which lithium ions are conducted in the aromatic compound having two or more amine groups may be less than or equal to about 10 kcal/mol, for example, less than or equal to about 8 kcal/mol, less than or equal to about 6 kcal/mol, or about 2 kcal/mol to about 6 kcal/mol.

The supramolecule may realize high ionic conductivity, for example, the ionic conductivity thereof according to electrochemical impedance spectroscopy (EIS) may be greater than or equal to about 1×10⁻⁴ S/cm, for example, 1×10⁻⁴ S/cm to about 1×10⁻³ S/cm, or about 1×10⁻⁴ S/cm to about 1×10⁻² S/cm.

The supramolecule of the present disclosure may realize not only desired ionic conduction properties but also excellent or suitable elastic force, self-healing properties, durability, mechanical strength, and adhesive force, and thus may effectively perform the role of a binder in a battery. For example, if (e.g., when) the supramolecule is applied as a binder to a negative electrode using a silicon-based negative electrode active material, the supramolecule may effectively suppress or reduce a volume expansion of the negative electrode due to charging and discharging, thereby improving the electrochemical performance and cycle-life characteristics of the battery.

In addition, if (e.g., when) the supramolecule is applied in a battery such as in a negative electrode, the formation of a solid-electrolyte-interphase (SEI) layer including Li₂CO₃, and/or the like. on the surface of the negative electrode after cycling, that is, at the interface between the negative electrode and the electrolyte, may be effectively alleviated. For example, before or after cycling the battery, for example, after 1 cycle, after 50 cycles, or after 100 cycles, Li₂CO₃ may not be observed on the surface of the negative electrode or may be observed only in a very small amount. The composition on the surface of the negative electrode may be determined through transmission electron microscopy-energy dispersive spectroscopy (TEM-EDS), X-ray photoelectron spectroscopy (XPS), or EIS analysis. For example, the supramolecule may effectively alleviate the formation of the SEI layer, thereby promoting the electrochemical reaction in the battery and maintaining the density of the electrode active material even if the cycle is repeated.

### Rechargeable Lithium Battery

According to one or more embodiments of the present disclosure, a rechargeable lithium battery may include a positive electrode, a negative electrode, a separator between the positive electrode and the negative electrode, and an electrolyte. The rechargeable lithium battery includes the aforementioned supramolecule, for example, one or more selected from among the positive electrode, the negative electrode, the separator, and the electrolyte may include the supramolecule. For example, in one or more embodiments, the supramolecule may be used for one or more selected from among a binder and a solid electrolyte of the rechargeable lithium battery, or for both (e.g., simultaneously) the binder and the solid electrolyte of the rechargeable lithium battery.

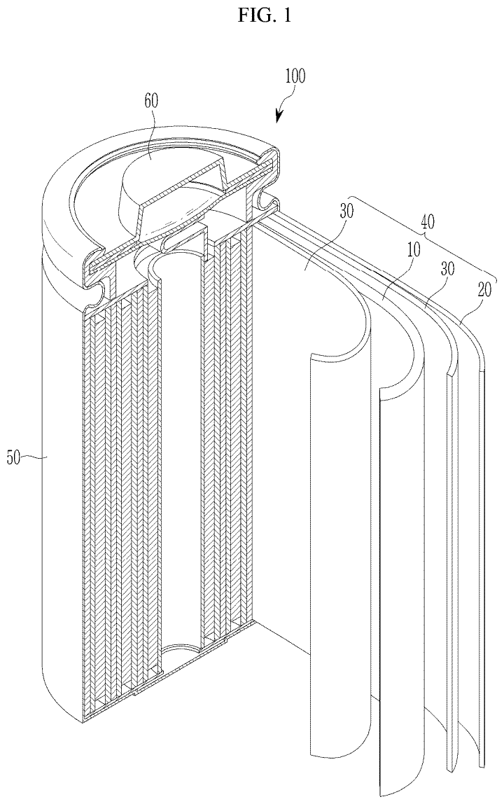

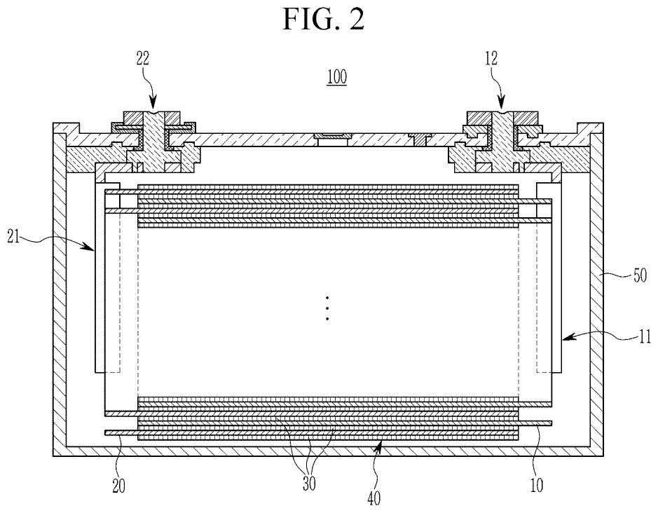

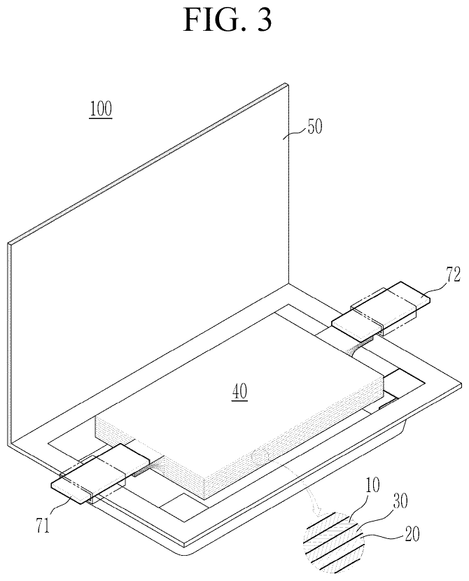

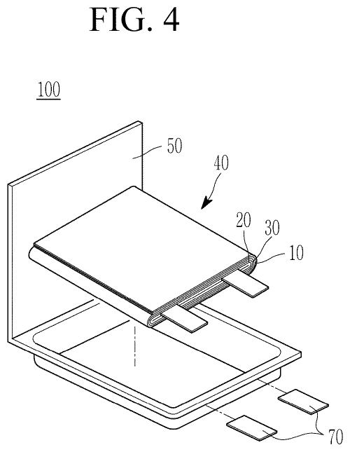

The rechargeable lithium battery may be classified into cylindrical, prismatic, pouch, coin, and/or the like. depending on the shape thereof. FIGS. 1 to 4 are each a schematic diagram showing a rechargeable lithium battery according to one or more embodiments, where FIG. 1 shows a cylindrical battery, FIG. 2 shows a prismatic battery, and FIGS. 3 and 4 each show a pouch-shaped battery. Referring to FIGS. 1 to 4, the rechargeable lithium battery 100 includes an electrode assembly 40 with a separator 30 interposed between a positive electrode 10 and a negative electrode 20, and a case 50 in which the electrode assembly 40 is housed. The positive electrode 10, the negative electrode 20, and the separator 30 may be impregnated with an electrolyte solution. In some embodiments, the rechargeable lithium battery 100 may include a sealing member 60 that seals the case 50 as shown in FIG. 1. In some embodiments, as shown in FIG. 2, the rechargeable lithium battery 100 may include a positive electrode lead tab 11, a positive electrode terminal 12, a negative lead tab 21, and a negative electrode terminal 22. In some embodiments, as shown in FIGS. 3 and 4, the rechargeable lithium battery 100 may include an electrode tab 70, that is, a positive electrode tab 71 and a negative electrode tab 72, serving as an electrical path for inducing the current formed in the electrode assembly 40 to the outside.

### Positive Electrode

In one or more embodiments, the positive electrode may include a positive electrode current collector and a positive electrode active material layer on the positive electrode current collector. The positive electrode active material layer includes a positive electrode active material (e.g., in a form of particles), and may further include a binder, a conductive material (e.g., electron conductor), and/or a (e.g., any suitable) combination thereof.

### Positive Electrode Active Material

The positive electrode active material may be a compound (lithiated intercalation compound) capable of intercalating and deintercalating lithium. For example, in one or more embodiments, one or more types (kinds) of composite oxides of lithium and a metal selected from among cobalt, manganese, nickel, and one or more (e.g., any suitable) combinations thereof may be used.

The composite oxide may be a lithium transition metal composite oxide, and non-limiting examples thereof may include a lithium nickel-based oxide, a lithium cobalt-based oxide, a lithium manganese-based oxide, a lithium iron phosphate-based compound, a cobalt-free lithium nickel-manganese-based oxide, and/or a (e.g., any suitable) combination thereof.

In one or more embodiments, a compound represented by any one selected from among the following chemical formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0<c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and/or LiₐFePO₄ (0.90≤a≤1.8).

in the foregoing chemical formulas, A may be nickel (Ni), cobalt (Co), manganese (Mn), or a (e.g., any suitable) combination thereof; X may be aluminum (Al), Ni, Co, Mn, chromium (Cr), iron (Fe), magnesium (Mg), strontium (Sr), vanadium (V), a rare earth element, or a (e.g., any suitable) combination thereof; D may be oxygen (O), fluorine (F), sulfur(S), phosphorous (P), or a (e.g., any suitable) combination thereof; G may be Al, Cr, Mn, Fe, Mg, lanthanum (La), cerium (Ce), Sr, V, and/or a (e.g., any suitable) combination thereof; and L¹ may be Mn, Al, or a (e.g., any suitable) combination thereof.

In one or more embodiments, the positive electrode active material may be a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of total metals excluding lithium in the positive electrode active material (e.g., in the lithium transition metal composite oxide). The high nickel-based positive electrode active material may achieve high capacity and may be applied to high-capacity, high-density rechargeable lithium batteries.

In one or more embodiments, an amount of the positive electrode active material may be about 90 wt % to about 98 wt %, for example, about 90 wt % to about 95 wt %, based on a total weight of the positive electrode active material layer. An amount of the binder and the conductive material may each be about 1 wt % to about 5 wt % based on the total weight of the positive electrode active material layer.

### Binder

The binder improves binding properties of positive electrode active material particles with one another and with the positive electrode current collector. The binder may include the supramolecule according to one or more embodiments and may further include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but embodiments of the present disclosure are not limited thereto.

### Conductive Material

The conductive material may be included to provide electrode conductivity, and any electrically conductive material may be used as a conductive material unless it causes a chemical change. Non-limiting examples of the conductive material may include a carbon-based material such as natural graphite, artificial graphite, carbon black, acetylene black, Ketjen black, a carbon fiber, a carbon nanofiber, a carbon nanotube, and/or the like; a metal-based material of a metal powder or a metal fiber each including copper, nickel, aluminum, silver, and/or the like; a conductive polymer such as a polyphenylene derivative; and/or a (e.g., any suitable) mixture thereof.

Each content (e.g., amount) of the binder and the conductive material may be about 0.5 wt % to about 5 wt % based on 100 wt % of a total weight of the positive electrode active material layer.

The positive electrode current collector may include aluminum (Al), but embodiments of the present disclosure are not limited thereto.

According to one or more embodiments, the positive electrode may include the aforementioned supramolecule. For example, in one or more embodiments, the positive electrode may include a positive electrode active material and the supramolecule. In one or more embodiments, the positive electrode may include a positive electrode active material, the supramolecule, and a conductive material. In the positive electrode, the supramolecule may function as a binder and/or a solid electrolyte. Based on 100 wt % of a total weight of the positive electrode active material layer, the supramolecule may be included in an amount of about 0.1 wt % to about 30 wt %, for example, about 0.1 wt % to about 20 wt %, about 0.1 wt % to about 10 wt %, about 0.5 wt % to about 5 wt %, or about 1 wt % to about 3 wt %. By including an appropriate or suitable amount of the supramolecule in the positive electrode, adhesive force may be increased and the conductivity of lithium ions may be improved.

In one or more embodiments, the supramolecule may act as a binder, so if (e.g., when) the supramolecule is included in the positive electrode, the positive electrode may not include (e.g., may exclude) an additional binder. In one or more embodiments, the positive electrode may include a positive electrode active material and the supramolecule and may further include an additional binder.

### Negative Electrode

The negative electrode may include a negative electrode current collector and a negative electrode active material layer on the negative electrode current collector. The negative electrode active material layer may include a negative electrode active material (e.g., in a form of particles), a binder, a conductive material (e.g., electron conductor), and/or a (e.g., any suitable) combination thereof.

### Negative Electrode Active Material

The negative electrode active material may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include, for example crystalline carbon, amorphous carbon, and/or a (e.g., any suitable) combination thereof as a carbon-based negative electrode active material. The crystalline carbon may be irregularly shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy may include an alloy of lithium and one or more metals selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (wherein Q may be an element selected from among an alkali metal, an alkaline-earth metal, a Group 13 element, a Group 14 element (excluding Si), a Group 15 element, a Group 16 element, a transition metal, a rare earth element, and/or a (e.g., any suitable) combination thereof, for example, magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (TI), germanium (Ge), phosphorous (P), arsenic (As), antimony (Sb), bismuth (Bi), sulfur(S), selenium (Se), tellurium (Te), polonium (Po), and/or a (e.g., any suitable) combination thereof), and/or a (e.g., any suitable) combination thereof. The Sn-based negative electrode active material may be Sn, SnOₓ (0<x≤2) (e.g., SnO₂), a Sn alloy, or a (e.g., any suitable) combination thereof.

The silicon-carbon composite may be a composite of silicon and amorphous carbon, in a form of particles. An average particle diameter (D₅₀) of the silicon-carbon composite particles may be, for example, about 0.5 microns (μm) to about 20 μm. According to one or more embodiments, the silicon-carbon composite may be in the form of silicon particles and amorphous carbon coated on the surface of each of the silicon particles. For example, in one or more embodiments, the silicon-carbon composite may include a secondary particle (core) in which silicon primary particles are assembled (e.g., agglomerated) and an amorphous carbon coating layer (shell) on the surface of the secondary particle. In one or more embodiments, the amorphous carbon may also be present between the silicon primary particles, for example, the silicon primary particles may be coated with amorphous carbon. The secondary particles may exist dispersed in an amorphous carbon matrix.

In one or more embodiments, the silicon-carbon composite may further include crystalline carbon. For example, the silicon-carbon composite may include a core including crystalline carbon and silicon particles and an amorphous carbon coating layer on the surface of the core. The crystalline carbon may be artificial graphite, natural graphite, or a (e.g., any suitable) combination thereof. The amorphous carbon may include soft carbon or hard carbon, a mesophase pitch carbonized product, and/or calcined coke.

If (e.g., when) the silicon-carbon composite includes silicon and amorphous carbon, a content (e.g., amount) of silicon may be about 10 wt % to about 50 wt % and a content (e.g., amount) of amorphous carbon may be about 50 wt % to about 90 wt %, based on 100 wt % of a total weight of the silicon-carbon composite. In addition, if (e.g., when) the silicon-carbon composite includes silicon, amorphous carbon, and crystalline carbon, a content (e.g., amount) of silicon may be about 10 wt % to about 50 wt %, a content (e.g., amount) of crystalline carbon may be about 10 wt % to about 70 wt %, and a content (e.g., amount) of amorphous carbon may be about 20 wt % to about 40 wt %, based on 100 wt % of a total weight of the silicon-carbon composite.

In one or more embodiments, a thickness of the amorphous carbon coating layer may be about 5 nanometers (nm) to about 100 nm. An average particle diameter (D₅₀) of the silicon particles (primary particles) may be about 10 nm to about 1 μm, or about 10 nm to about 200 nm. The silicon particles may exist as silicon alone, in the form of a silicon alloy, or in an oxidized form. The oxidized form of silicon may be represented by SiOₓ (0<x≤2). In this regard, an atomic content (e.g., amount) ratio of Si:O, which indicates a degree of oxidation, may be about 99:1 to about 33:67. As used herein, if (e.g., when) a definition is not otherwise provided, an average particle diameter (D₅₀) indicates a particle where an accumulated volume is about 50 volume % in a particle distribution.

In one or more embodiments, the Si-based negative electrode active material or Sn-based negative electrode active material may be mixed with the carbon-based negative electrode active material. If (e.g., when) the Si-based negative electrode active material or Sn-based negative electrode active material and the carbon-based negative electrode active material are mixed and used, a mixing ratio thereof may be a weight ratio of about 1:99 to about 90:10.

### Binder

The binder serves to suitably and/or well adhere the negative electrode active material particles to each other and also to adhere the negative electrode active material to the negative electrode current collector. The binder may include the supramolecule according to one or more embodiments, and may further include a non-aqueous binder (e.g., a water-insoluble binder), an aqueous binder (e.g., a water-soluble), a dry binder, and/or a (e.g., any suitable) combination thereof, but embodiments of the present disclosure are not limited thereto.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

If (e.g., when) an aqueous binder is used as the binder of the negative electrode, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber, and may be, for example, polytetrafluoroethylene, polyvinylidene fluoride, a polyvinylidene fluoride-hexafluoropropylene copolymer, polyethylene oxide, or a (e.g., any suitable) combination thereof.

### Conductive Material

The conductive material (e.g., electron conductor) may be included to provide electrode conductivity and any electrically conductive material may be used as a conductive material unless it causes a chemical change. Non-limiting examples of the conductive material may include a carbon-based material such as natural graphite, artificial graphite, carbon black, acetylene black, Ketjen black, a carbon fiber, a carbon nanofiber, a carbon nanotube, and/or the like; a metal-based material of a metal powder or a metal fiber each including copper, nickel, aluminum, silver, and/or the like; a conductive polymer such as a polyphenylene derivative; and/or a (e.g., any suitable) mixture thereof.

In one or more embodiments, a content (e.g., amount) of the negative electrode active material may be about 95 wt % to about 99.5 wt % based on 100 wt % of a total weight of the negative electrode active material layer, and a content (e.g., amount) of the binder may be about 0.5 wt % to about 5 wt % based on 100 wt % of the total weight of the negative electrode active material layer. For example, in one or more embodiments, the negative electrode active material layer may include about 90 wt % to about 99 wt % of the negative electrode active material, about 0.5 wt % to about 5 wt % of the binder, and about 0.5 wt % to about 5 wt % of the conductive material, based on 100 wt % of the total weight of the negative electrode active material layer.

### Negative Electrode Current Collector

The negative electrode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, a sheet, or a foam. A thickness of the negative electrode current collector may be, for example, about 1 μm to about 20 μm, about 5 μm to about 15 μm, or about 7 μm to about 10 μm.

According to one or more embodiments, the negative electrode may include the aforementioned supramolecule. For example, in one or more embodiments, the negative electrode may include a negative electrode active material and the supramolecule. In the negative electrode, the supramolecule may function as a binder and/or a solid electrolyte. Based on 100 wt % of a total weight of the negative electrode active material layer, the supramolecule may be included in an amount of about 0.1 wt % to about 30 wt %, for example, about 0.1 wt % to about 20 wt %, about 0.1 wt % to about 10 wt %, about 0.5 wt % to about 5 wt %, or about 1 wt % to about 3 wt %. By including an appropriate or suitable amount of supramolecular particles in the negative electrode, adhesive force may be increased and the conductivity of lithium ions may be increased.

In one or more embodiments, the supramolecule may act as a binder, so if (e.g., when) the supramolecule is included in the negative electrode, the negative electrode may not include an (e.g., may exclude any) additional binder. In one or more embodiments, the negative electrode may include a negative electrode active material and the supramolecule and may further include an additional binder.

In one or more embodiments, the negative electrode for a rechargeable lithium battery may include a silicon-based negative electrode active material and the supramolecule. The silicon-based negative electrode active material has a problem/issue in that the volume thereof changes significantly during charging and discharging. However, the supramolecule according to one or more embodiments has a crosslinked structure by hydrogen bonding, thereby effectively suppressing or reducing the volume change due to charging and discharging of the silicon-based negative electrode active material. In one or more embodiments, the negative electrode may include a silicon-based negative electrode active material, a graphite-based negative electrode active material, and the supramolecule. Such a negative electrode may achieve high capacity and effectively suppress or reduce volume expansion due to charging and discharging, thereby realizing excellent or suitable cycle-life characteristics.

### Electrolyte

In one or more embodiments, the electrolyte for a rechargeable lithium battery may be an electrolyte solution, which may include a non-aqueous organic solvent and a lithium salt.

The non-aqueous organic solvent serves as a medium for transmitting ions taking part in the electrochemical reaction of the rechargeable lithium battery. The non-aqueous organic solvent may be a carbonate-based solvent, an ester-based solvent, an ether-based solvent, a ketone-based solvent, an alcohol-based solvent, an aprotic solvent, or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, decanolide, mevalonolactone, valerolactone, caprolactone, and/or the like. The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R—CN (wherein R is a C₂ to C₂₀ linear, branched, or cyclic hydrocarbon group, and may include a double bond, an aromatic ring, or an ether bond, and/or the like; amides such as dimethylformamide; dioxolanes such as 1,3-dioxolane, 1,4-dioxolane, and/or the like; sulfolanes; and/or the like.

The non-aqueous organic solvent may be used alone or as a mixture of two or more, and if (e.g., when) two or more types (kinds) are mixed and used, a mixing ratio may be appropriately or suitably adjusted depending on the desired or suitable battery performance, which is widely understood by those working in the field.

If (e.g., when) using a carbonate-based solvent, a cyclic carbonate and a chain carbonate may be mixed and used, and the cyclic carbonate and the chain carbonate may be mixed in a volume ratio of about 1:1 to about 1:9.

In one or more embodiments, the non-aqueous organic solvent may further include an aromatic hydrocarbon-based organic solvent. For example, in some embodiments, a carbonate-based solvent and an aromatic hydrocarbon-based organic solvent may be mixed and used in a volume ratio of about 1:1 to about 30:1.

In one or more embodiments, the electrolyte solution may further include vinylethylene carbonate, vinylene carbonate, or an ethylene carbonate-based compound to improve battery cycle-life.

Non-limiting examples of the ethylene carbonate-based compound may include fluoroethylene carbonate, difluoroethylene carbonate, chloroethylene carbonate, dichloroethylene carbonate, bromoethylene carbonate, dibromoethylene carbonate, nitroethylene carbonate, and cyanoethylene carbonate.

The lithium salt dissolved in the non-aqueous organic solvent supplies lithium ions in the rechargeable lithium battery, enables a basic operation of the rechargeable lithium battery, and improves transportation of the lithium ions between positive and negative electrodes. Non-limiting examples of the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl) imide; LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethane sulfonate, lithium difluorobis(oxalato)phosphate (LiDFOP), and lithium bis(oxalato) borate (LiBOB).

The lithium salt may be used in a concentration in a range of about 0.1 M to about 2.0 M. If (e.g., when) the concentration of lithium salt is within the above range, the electrolyte solution has appropriate or suitable ionic conductivity and viscosity, and thus excellent or suitable performance may be achieved and lithium ions can move effectively.

The supramolecule according to one or more embodiments has low reactivity and high miscibility with the aforementioned electrolyte solution, and may be suitable for application to lithium ion batteries using the electrolyte solution.

### Separator

Depending on the type or kind of the rechargeable lithium battery, a separator may be present between the positive electrode and the negative electrode. The separator may include polyethylene, polypropylene, polyvinylidene fluoride, or a multilayer film of two or more layers thereof, or a mixed multilayer film such as a polyethylene/polypropylene two-layer separator, a polyethylene/polypropylene/polyethylene three-layer separator, a polypropylene/polyethylene/polypropylene three-layer separator, and/or the like.

The separator may include a porous substrate and a coating layer including an organic material, an inorganic material, and/or a (e.g., any suitable) combination thereof on one or both (e.g., simultaneously) surfaces (e.g., two opposite surfaces) of the porous substrate.

The porous substrate may be a polymer film formed of any one polymer selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or a mixture of two or more thereof.

The porous substrate may have a thickness of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and/or a structural unit derived from (meth)acrylamidosulfonic acid or a salt thereof.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but embodiments of the present disclosure are not limited thereto. An average particle diameter (D₅₀) of the inorganic particles may be about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

A thickness of the coating layer may be about 0.5 μm to about 20 μm, for example, about 1 μm to about 10 μm, or about 1 μm to about 5 μm.

The separator according to one or more embodiments may include the above-described supramolecule. In the separator, the supramolecule may serve as a binder and/or a solid electrolyte. Based on 100 wt % of a total weight of the separator, the supramolecule may be included in an amount of about 0.01 wt % to about 30 wt %, for example, about 0.05 wt % to about 20 wt %, about 0.1 wt % to about 10 wt %, about 0.5 wt % to about 5 wt %, or about 1 wt % to about 3 wt %. By including an appropriate or suitable amount of the supramolecule in the separator, adhesive force may be increased and the conductivity of lithium ions may be improved.

### All-Solid-State Rechargeable Battery

In one or more embodiments, an all-solid-state rechargeable battery may include a positive electrode, a negative electrode, and a solid electrolyte layer between the positive electrode and the negative electrode, wherein at least one of the positive electrode, the negative electrode, or the solid electrolyte layer may include the supramolecule. Herein, the all-solid rechargeable battery is a battery using a solid electrolyte, and does not exclude liquid components. It may be an all-solid rechargeable battery in which all components of the battery are solid, or a semi-solid rechargeable battery including a portion of liquid or gel phase.

### Positive Electrode

The positive electrode for an all-solid-state rechargeable battery may include a positive electrode current collector and a positive electrode active material layer on the positive electrode current collector. The positive electrode active material layer may include a positive electrode active material and may further include a solid electrolyte, a binder, a conductive material (e.g., electron conductor), and/or a (e.g., any suitable) combination thereof.

In one or more embodiments, the positive electrode active material layer may optionally further include a solid electrolyte. The solid electrolyte may include the supramolecule according to one or more embodiments. In one or more embodiments, the solid electrolyte may further include a sulfide-based solid electrolyte, an oxide-based solid electrolyte, a halide-based solid electrolyte, and/or a (e.g., any suitable) combination thereof, and detailed descriptions thereof will be provided later in the solid electrolyte layer section.

Based on 100 wt % of a total weight of the positive electrode active material layer, the solid electrolyte may be included in an amount of about 0.1 wt % to about 35 wt %, for example, about 1 wt % to about 35 wt %, about 5 wt % to about 30 wt %, about 8 wt % to about 25 wt %, or about 10 wt % to about 20 wt %.

The positive electrode active material layer may include about 65 wt % to about 99 wt % of the positive electrode active material and about 1 wt % to about 35 wt % of the solid electrolyte, for example, about 80 wt % to about 90 wt % of the positive electrode active material and about 10 wt % to about 20 wt % of the solid electrolyte, based on a total weight of 100 wt % of the positive electrode active material and the solid electrolyte. If (e.g., when) the solid electrolyte is included in the positive electrode at such an amount, the efficiency and cycle-life characteristics of the all-solid-state rechargeable battery may be improved without reducing the capacity.

The description of the positive electrode active material, the binder, and the conductive material is the same as that of the positive electrode section of the rechargeable lithium battery section described above.

The positive electrode for an all-solid-state rechargeable battery according to one or more embodiments may include a positive electrode active material and the aforementioned supramolecule. Here, the supramolecule may serve as a binder and/or a solid electrolyte. Based on 100 wt % of a total weight of the positive electrode active material layer, the supramolecule may be included in an amount of about 0.1 wt % to about 30 wt %, for example, about 0.1 wt % to about 20 wt %, about 0.1 wt % to about 10 wt %, about 0.5 wt % to about 5 wt %, or about 1 wt % to about 3 wt %. By including an appropriate or suitable amount of supramolecule in the positive electrode, adhesive force may be increased and the conductivity of lithium ions may be increased.

### Negative Electrode

The negative electrode for an all-solid-state rechargeable battery may include a negative electrode current collector and a negative electrode active material layer on the negative electrode current collector. The negative electrode active material layer includes a negative electrode active material and may further include a binder and/or a conductive material (e.g., electron conductor).

The description of the negative electrode active material, the binder, and the conductive material is the same as that of the negative electrode section of the rechargeable lithium battery section described above.

The negative electrode for an all-solid-state rechargeable battery according to one or more embodiments may include a negative electrode active material and the aforementioned supramolecule. In the negative electrode, the supramolecule may serve as a binder and/or a solid electrolyte. Based on 100 wt % of a total weight of the negative electrode active material layer, the supramolecule may be included in an amount of about 0.1 wt % to about 30 wt %, for example, about 0.1 wt % to about 20 wt %, about 0.1 wt % to about 10 wt %, about 0.5 wt % to about 5 wt %, or about 1 wt % to about 3 wt %. By including an appropriate or suitable amount of the supramolecule in the negative electrode, adhesive force may be increased and the conductivity of lithium ions may be increased.

### Precipitation-Type or Kind Negative Electrode

In one or more embodiments, the negative electrode for an all-solid-state rechargeable battery may be a precipitation-type or kind negative electrode, unlike the negative electrode described in the field of lithium ion batteries. The precipitation-type or kind negative electrode does not include a negative electrode active material during battery assembly, but may refer to a negative electrode in which lithium metal, and/or the like, is precipitated or electrodeposited on the negative electrode during battery charging, thereby serving as a negative electrode active material.

The precipitation-type or kind negative electrode may include a negative electrode current collector and a negative electrode coating layer on the negative electrode current collector. In an all-solid-state rechargeable battery having such a precipitation-type or kind negative electrode, initial charging begins in the absence of negative electrode active material, and during charging, high-density lithium metal is precipitated or electrodeposited between the negative electrode current collector and the negative electrode coating layer and/or on the negative electrode coating layer to form a lithium metal layer, which may serve as a negative electrode active material. Accordingly, in an all-solid-state rechargeable battery that has been charged at least once, the precipitation-type or kind negative electrode may include, for example, a negative electrode current collector, a lithium metal layer on the negative electrode current collector, and a negative electrode coating layer on the metal layer. The lithium metal layer may be referred to as a layer in which lithium metal, and/or the like is precipitated during the charging process of the battery, and may be referred to as a metal layer, a lithium layer, a lithium electrodeposition layer, or a negative electrode active material layer.

The negative electrode coating layer may be referred to as a lithium electrodeposition inducing layer or a negative electrode catalyst layer, and may include a lithiophilic metal, a carbon material, and/or a (e.g., any suitable) combination thereof.

The lithiophilic metal may include, for example, gold, platinum, palladium, silicon, silver, aluminum, bismuth, tin, zinc, and/or a (e.g., any suitable) combination thereof, and may be composed of one of these lithiophilic metals or one or more suitable types (kinds) of alloys thereof. If (e.g., when) the lithiophilic metal exists in particle form (e.g., in the form of particles), an average particle diameter (D₅₀) thereof may be less than or equal to about 4 μm, for example, about 10 nm to about 4 μm, about 10 nm to about 1 μm, or about 10 nm to about 600 nm. For example, in one or more embodiments, the lithiophilic metal may be in the form of nanoparticles with an average particle diameter of several to hundreds of nanometers.

The carbon material may be, for example, crystalline carbon, amorphous carbon, or a (e.g., any suitable) combination thereof. The crystalline carbon may be, for example, natural graphite, artificial graphite, mesophase carbon microbeads, or a (e.g., any suitable) combination thereof. The amorphous carbon may be, for example, carbon black, activated carbon, acetylene black, Denka black, Ketjen black, or a (e.g., any suitable) combination thereof.

If (e.g., when) the negative electrode coating layer includes both (e.g., simultaneously) a lithiophilic metal and a carbon material, a mixing ratio of the lithiophilic metal and the carbon material may be, for example, a weight ratio of about 1:10 to about 2:1. As such, precipitation of lithium metal may be effectively promoted, and the characteristics of the all-solid-state rechargeable battery may be improved. For example, in one or more embodiments, the negative electrode coating layer may include a carbon material on which a lithiophilic metal is supported, or it may include a mixture of lithiophilic metal particles and carbon material particles.

In one or more embodiments, the negative electrode coating layer may include a lithiophilic metal and amorphous carbon; as such, it may effectively promote precipitation of lithium metal.

### Supported Compound

In one or more embodiments, the negative electrode coating layer may include a compound in which a lithiophilic metal is supported on a carbon material, also referred as supported compound herein. The supported compound is distinguished from a simple mixture of lithiophilic metal and carbon material. If (e.g., when) the negative electrode coating layer includes a supported compound, the lithium metal layer described in more detail later may be formed more uniformly (e.g., substantially uniformly), and the reversibility of precipitation and dissociation of lithium may be improved, thereby improving the cycle-life characteristics of the all-solid-state rechargeable battery. Herein, the lithiophilic metal is the same as described above, and the carbon material may be, for example, amorphous carbon (e.g., amorphous carbon material).

In one or more embodiments, the amorphous carbon material may be a single particle (e.g., in a form of single particles or monolithic particles), or may be an assembly having a form of secondary particles in each of which primary particles are assembled (e.g., agglomerated). If (e.g., when) the amorphous carbon material is a form of single particles, an average particle diameter thereof may be less than or equal to about 100 nm, for example, a nano size of about 10 nm to about 100 nm. If (e.g., when) the amorphous carbon material is an assembly, a particle size or an average particle size of the primary particles may be about 20 nm to about 100 nm, and a particle size or an average particle size of the secondary particles may be about 1 μm to about 20 μm.

In one or more embodiments, a particle size (e.g., average particle size) of the primary particles of the assembly-shaped amorphous carbon material may be greater than or equal to about 20 nm, greater than or equal to about 30 nm, greater than or equal to about 40 nm, greater than or equal to about 50 nm, greater than or equal to about 60 nm, greater than or equal to about 70 nm, greater than or equal to about 80 nm, or greater than or equal to about 90 nm and may be less than or equal to about 100 nm, less than or equal to about 90 nm, less than or equal to about 80 nm, less than or equal to about 70 nm, less than or equal to about 60 nm, less than or equal to about 50 nm, less than or equal to about 40 nm, or less than or equal to about 30 nm. The shape of the primary particle may be spherical, elliptical, plate-shaped, and/or one or more (e.g., any suitable) combinations thereof. In one or more embodiments, the shape of the primary particle may be spherical, elliptical, or a (e.g., any suitable) combination thereof.

In one or more embodiments, a particle diameter/size (e.g., average particle diameter/size) of the secondary particles of the assembly-shaped amorphous carbon material may be greater than or equal to about 1 μm, greater than or equal to about 3 μm, greater than or equal to about 5 μm, greater than or equal to about 7 μm, greater than or equal to about 10 μm, or greater than or equal to about 15 μm, and less than or equal to about 20 μm, less than or equal to about 15 μm, less than or equal to about 10 μm, less than or equal to about 7 μm, less than or equal to about 5 μm, or less than or equal to about 3 μm.

The lithiophilic metal may be included in an amount of about 33 wt % to about 40 wt %, for example, about 3 wt % to about 30 wt %, about 4 wt % to about 25 wt %, about 5 wt % to about 20 wt %, or about 5 wt % to about 15 wt %, based on 100 wt % of a total weight of the compound in which the lithiophilic metal is supported on the carbon material. The carbon material may be included in an amount of about 60 wt % to about 97 wt %, for example, about 70 wt % to about 97 wt %, about 75 wt % to about 96 wt %, about 80 wt % to about 95 wt %, or about 85 wt % to about 95 wt %, based on 100 wt % of the total weight of the compound in which the lithiophilic metal is supported on the carbon material. If (e.g., when) the amounts of the lithiophilic metal and carbon material each satisfies the above ranges, a substantially uniform lithium metal layer may be effectively formed during charging.

In one or more embodiments, the carbon material and the lithiophilic metal may be chemically bonded through sulfur. For example, the carbon material and the lithiophilic metal may not be simply physically mixed but may be chemically bonded to each other. As such, the bonding power/strength between the carbon material and the lithiophilic metal is excellent or suitable, and the problem of the carbon material and the lithiophilic metal being separated from each other during a mixing process may be effectively prevented or reduced. Additionally, the phenomenon of aggregation of lithiophilic metals is prevented or reduced, and the lithiophilic metals may be uniformly (e.g., substantially uniformly) dispersed within the negative electrode coating layer, thereby making the current distribution within the negative electrode substantially uniform and leading to substantially uniform precipitation of lithium metal.

If (e.g., when) a carbon material and a lithiophilic metal are chemically bonded through sulfur, a peak related to the bond between the lithiophilic metal and sulfur can be confirmed in the X-ray photoelectron spectroscopy (XPS) spectrum. For example, if (e.g., when) the lithiophilic metal includes Ag, a peak can be confirmed in the range of about 160 eV to about 162 eV, which is the Ag—S binding energy, in the S2p spectrum obtained by XPS analysis.

A composite (e.g., a supported compound) in which a carbon material and a lithiophilic metal are chemically bonded through sulfur may be prepared by mixing the carbon material and sulfur-containing raw materials in a dry or wet manner, optionally heat-treating them, and then supporting and heat-treating the lithiophilic metal.

In one or more embodiments, a method of supporting a lithiophilic metal may be, for example, a method of mixing a mixture of a carbon material and a sulfur-containing raw material, a lithiophilic metal compound, and a reducing agent in a solvent. The solvent may include, for example, water, ethanol, glycerol, benzene, xylene, and/or a (e.g., any suitable) combination thereof, and the reducing agent may include NaBH₄, ascorbic acid, trisodium citrate, ethylene glycol, and/or a (e.g., any suitable) combination thereof. The lithiophilic metal compound may be a nitrate, a sulfate, a perchlorate, and/or the like, containing a lithiophilic metal, and may include, for example, AgNO₃, Ag₂SO₄, AgClO₄, and/or a (e.g., any suitable) combination thereof.

The heat treatment after lithiophilic metal loading may usually be carried out at a temperature at which the sulfur-containing raw material can be decomposed and removed, for example, about 100° C. to about 500° C., about 150° C. to about 500° C., about 200° C. to about 450° C., or about 200° C. to about 400° C. For example, if (e.g., when) using a thiol compound as a sulfur-containing raw material, it may be heat treated at about 100° C. to about 400° C. The heat treatment may be performed for about 2 to about 20 hours in an atmosphere of nitrogen, argon, or a (e.g., any suitable) combination thereof.

A thickness of the negative electrode coating layer may be, for example, about 100 nm to about 40 μm, or about 500 nm to about 30 μm, or about 1 μm to about 20 μm. If the negative electrode coating layer satisfies the above thickness range, a lithium metal layer of substantially uniform thickness may be effectively formed during charging.

In one or more embodiments, the negative electrode coating layer may further include a binder, for example, a conductive binder. Additionally, the negative electrode coating layer may further include an additive such as a filler, a dispersant, an ion conductive agent, and/or the like.

The binder of the negative electrode coating layer may include a non-aqueous binder (e.g., water-insoluble binder), an aqueous binder (e.g., water-soluble binder), a dry binder, and/or a (e.g., any suitable) combination thereof.

The non-aqueous binder may include polyvinylchloride, carboxylated polyvinylchloride, polyvinylfluoride, an ethylene propylene copolymer, polystyrene, polyurethane, polytetrafluoroethylene, polyvinylidene fluoride, polyethylene, polypropylene, polyamideimide, polyimide, and/or a (e.g., any suitable) combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

If (e.g., when) an aqueous binder is used as the binder of the negative electrode, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber, and may be, for example, polytetrafluoroethylene, polyvinylidene fluoride, a polyvinylidene fluoride-hexafluoropropylene copolymer, polyethylene oxide, or a (e.g., any suitable) combination thereof.

The binder may be included in an amount of about 0.1 to about 5 wt %, about 0.1 to about 3 wt %, or about 0.5 to about 2 wt %, based on 100 wt % of a total weight of the negative electrode coating layer.

### Lithium Metal Layer

The negative electrode according to one or more embodiments may be a type or kind of precipitation-type or kind negative electrode, and the all-solid-state rechargeable battery including the negative electrode begins initial charging in the absence of a negative electrode active material, and during charging, a lithium metal layer is formed by precipitation or electrodeposition of high-density lithium metal between the negative electrode current collector and the negative electrode coating layer and/or on the negative electrode coating layer, which may serve as a negative electrode active material. Therefore, the all-solid-state rechargeable battery that has been charged at least once may include, for example, the negative electrode current collector, a lithium metal layer on the negative electrode current collector, and the negative electrode coating layer on the lithium metal layer. The lithium metal layer refers to a layer in which lithium ions are precipitated as lithium metal during the charging process of the battery, and may be expressed as a metal layer, a lithium layer, a lithium electrodeposition layer, or a negative electrode active material layer.

The lithium metal layer may include a lithium metal or a lithium alloy. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer may be about 1 μm to about 500 μm, about 5 μm to about 500 μm, about 5 μm to about 400 μm, about 5 μm to about 300 μm, or about 10 μm to about 200 μm. If the thickness of the lithium metal layer is too thin, it is difficult to function as a lithium storage layer, and if it is too thick, performance may decrease as the battery volume increases.

In one or more embodiments, a lithium metal layer with a substantially uniform and flat thickness may be formed by applying a compound in which the aforementioned lithiophilic metal is supported on a carbon material to the negative electrode coating layer. Therefore, according to one or more embodiments, the lithium metal layer formed during charging may have a very (substantially) uniform thickness and have a small thickness deviation. For example, in one or more embodiments, a deviation of the thickness of the lithium metal layer may be less than or equal to about 40%, less than or equal to about 30%, less than or equal to about 20%, less than or equal to about 15%, less than or equal to about 10%, or less than or equal to about 5%. For example, a deviation of the thickness of a coating layer may be calculated by measuring the thickness of about 10 points in an electron microscope image of the cross-section of a negative electrode to calculate an arithmetic average, and then dividing the absolute value of the difference between one measured data and the arithmetic mean value by the arithmetic mean value and multiplying by 100. Also, for example, the thickness of the lithium metal layer may be about 5 μm to about 80 μm, and the standard deviation of the thickness may be about 0.1 μm to about 20 μm, about 0.1 μm to about 15 μm, about 0.1 μm to about 10 μm, about 0.1 μm to about 5 μm, or about 0.1 μm to about 3 μm. Likewise, the standard deviation of the thickness of the lithium metal layer may be calculated by measuring the thickness of about 10 points in an electron microscope image. If the deviation or standard deviation of the thickness of the lithium metal layer satisfies the above range, it refers to that lithium metal is well precipitated in the form of a film of substantially uniform thickness, and thus the electrochemical properties of the all-solid-state rechargeable battery may be improved.

### Others

The precipitation-type or kind negative electrode according to one or more embodiments may further include a thin film on the surface of the negative electrode current collector, that is, between the negative electrode current collector and the negative electrode coating layer, or between the negative electrode current collector and the lithium metal layer. The thin film may include an element capable of forming an alloy with lithium. The thin film may include elements that can form an alloy with lithium. Elements that can form alloys with lithium may include, for example, Al, Ag, Au, Bi, Cu, Ge, In, Mg, Ni, Pd, Pt, Si, Sn, Zn, and/or a (e.g., any suitable) combination thereof. The thin film may further planarize the precipitation form of the lithium metal layer and help form a lithium metal layer of substantially uniform thickness. The thin film may be formed, for example, in a vacuum deposition method, a sputtering method, a plating method, and/or the like. The thin film may have, for example, a thickness of about 1 nm to about 500 nm.

### Solid Electrolyte Layer

The solid electrolyte layer includes a solid electrolyte. The solid electrolyte may be a type or kind of polymer-based solid electrolyte and may include the aforementioned supramolecule. In one or more embodiments, the solid electrolyte may include a type or kind of inorganic solid electrolyte, for example, a sulfide-based solid electrolyte, an oxide-based solid electrolyte, a halide-based solid electrolyte, and/or a (e.g., any suitable) combination thereof. The solid electrolyte layer according to one or more embodiments may include one or both (e.g., simultaneously) of the supramolecule and the inorganic solid electrolyte. The supramolecule may act as a solid electrolyte in the solid electrolyte layer and at the same time act as a binder, so that a stable solid electrolyte layer may be implemented even without using an additional binder.

### Sulfide-Based Solid Electrolyte

The sulfide-based solid electrolyte may include, for example, Li₂S—P₂S₅, Li₂S—P₂S₅—LiX (wherein X is a halogen element, for example, I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are each an integer, and Z may be Ge, Zn, or Ga), Li₂S—GeS₂, Li₂S—SiS₂—Li₃PO₄, Li₂S—SiS₂-LiₚMO_{q} (wherein p and q are each an integer, and M may be P, Si, Ge, B, Al, Ga, or In), and/or a (e.g., any suitable) combination thereof.

In one or more embodiments, the sulfide-based solid electrolyte may be obtained by, for example, mixing Li₂S and P₂S₅ in a molar ratio of about 50:50 to about 90:10 or about 50:50 to about 80:20 and optionally performing heat-treatment. Within the above mixing ratio range, a sulfide-based solid electrolyte having excellent or suitable ionic conductivity may be prepared. The ionic conductivity may be further improved by adding SiS₂, GeS₂, B₂S₃, and/or the like as other components thereto.

In one or more embodiments, mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. In some embodiments, the sulfide-based solid electrolyte may be prepared by mixing sulfur-containing raw materials and performing heat treatment two or more times. In these embodiments, a sulfide-based solid electrolyte having high ionic conductivity and robustness may be prepared.

The sulfide-based solid electrolyte particles according to one or more embodiments, for example, may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed in an inert gas or nitrogen atmosphere, separately. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide-based solid electrolyte having high ionic conductivity and high performance may be obtained, and such a solid electrolyte may be suitable for mass production. The temperature of the first heat treatment may be, for example, about 150° C. to about 330° C., or about 200° C. to about 300° C., and the temperature of the second heat treatment may be, for example, about 380° C. to about 700° C., or about 400° C. to about 600° C.

In one or more embodiments, the sulfide-based solid electrolyte particles may include argyrodite-type or kind sulfide. The argyrodite-type or kind sulfide-based solid electrolyte particle may have high ionic conductivity close to the range of about 10⁻⁴ to about 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer (e.g., positive/negative electrode active material layer) and the solid electrolyte layer. An all-solid-state rechargeable battery including such argyrodite-type or kind sulfide-based solid electrolytes may have improved battery performance such as rate capability, coulombic efficiency, and cycle-life characteristics.

In one or more embodiments, the argyrodite-type or kind sulfide-based solid electrolyte in a form of particles may include a compound represented by Chemical Formula 21.

(LiₐM¹_{b}M²_{c})(P_{d}M³ₑ)(S_{f}M⁴_{g})Xₕ Chemical Formula 21

In Chemical Formula 21, 4≤a≤8, M¹ may be Mg, Cu, Ag, or a (e.g., any suitable) combination thereof, 0≤b<0.5, M² may be Na, K, or a (e.g., any suitable) combination thereof, 0≤c<0.5, M³ may be Sn, Zn, Si, Sb, Ge, or a (e.g., any suitable) combination thereof, 0<d<4, 0≤e<1, M⁴ may be O, SOₙ, or a (e.g., any suitable) combination thereof, 1.5≤n≤5, 3≤f≤12, 0≤g<2, X may be F, Cl, Br, I, or a (e.g., any suitable) combination thereof, and 0≤h≤2.

In one or more embodiments, in Chemical Formula 21, a halide element (X) may be included, and in these embodiments, it may be expressed as 0<h≤2. In one or more embodiments, the M¹ element may be included in Chemical Formula 21, and in these embodiments, it may be expressed as 0<b<0.5. In Chemical Formula 21, M³ may be understood as an element substituted for P and may be 0<e<1. In Chemical Formula 21, M⁴ is substituted for S and, for example, may be 0<g<2, and f, a ratio of S, may be, for example, 3≤f≤7. When M⁴ is SOₙ, SOₙ may be, for example, S₄O₆, S₃O₆, S₂O₃, S₂O₄, S₂O₅, S₂O₆, S₂O₇, S₂O₈, SO₄, or SO₅. For example, in some embodiments, M⁴ may be SO₄.

In one or more embodiments, in Chemical Formula 21, a+b+c+h=7, d+e=1, and f+g+h=6.

In one or more embodiments, the argyrodite-type or kind sulfide-based solid electrolyte in a form of particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06}) PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025}) Cl_{1.25}, and/or a (e.g., any suitable) combination thereof, but embodiments of the present disclosure are not limited thereto.

The argyrodite-type or kind sulfide-based solid electrolyte may be prepared, for example, by mixing raw materials of lithium sulfide and phosphorus sulfide, and optionally lithium halide. Heat treatment may be performed after mixing the raw materials. The heat treatment may be carried out at a temperature range of about 400° C. to about 600° C., for example, about 450° C. to about 500° C., or about 460° C. to about 490° C., for about 5 hours to about 30 hours, about 10 hours to about 24 hours, or about 15 hours to about 20 hours. If (e.g., when) the heat treatment is carried out under the above conditions, ionic conductivity may be maximized or increased. In one or more embodiments, the heat treatment may include, for example, two or more heat treatment steps. The method of preparing the argyrodite-type or kind sulfide-based solid electrolyte may include, for example, a first heat treatment in which raw materials are mixed and fired at about 120° C. to about 350° C., and a second heat treatment in which the resultant of the first heat treatment is mixed again and fired at about 350° C. to about 800° C.

An average particle diameter (D₅₀) of the sulfide-based solid electrolyte particles may be, for example, about 0.1 μm to about 5.0 μm or about 0.1 μm to about 3.0 μm, or may be small particles of about 0.1 μm to about 1.9 μm or large particles of about 2.0 μm to about 5.0 μm. In one or more embodiments, the sulfide-based solid electrolyte particles may be a mixture of small particles of about 0.1 μm to about 1.9 μm and large particles of about 2.0 μm to about 5.0 μm. The average particle diameter of the sulfide-based solid electrolyte particles may be measured using an electron microscope image, and for example, a particle size distribution may be obtained by measuring the size (diameter or the major axis length) of about 20 particles in a scanning electron microscope image, and D₅₀ may be calculated therefrom.

### Oxide-Based Solid Electrolyte

The oxide-based solid electrolyte may include, for example, Li₁₊ₓTi₂₋ₓAl(PO₄)₃ (LTAP) (0≤x≤2), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), Pb(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄d), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; x is an integer of 1 to 10), and/or a (e.g., any suitable) mixture thereof.

### Halide-Based Solid Electrolyte

In one or more embodiments, the solid electrolyte layer may further include, for example, a halide-based solid electrolyte. The halide-based solid electrolyte may include a halogen element as a main component, meaning that a ratio of the halide element to all elements constituting the solid electrolyte is about 50 mol % or more, about 70 mol % or more, about 90 mol % or more, or about 100 mol %. For example, the halide-based solid electrolyte may not include (e.g., may exclude) sulfur element.

The halide-based solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sn, Ta, Ti, Y, Zn, Zr, and/or a (e.g., any suitable) combination thereof. The halogen element may be F, Cl, Br, I, or a (e.g., any suitable) combination thereof, and for example, the halogen element may be Cl, Br, or a (e.g., any suitable) combination thereof. In one or more embodiments, the halide-based solid electrolyte may be, for example, represented by LiₐM₁X₆ (M may be Al, As, B, Bi, Ca, Cd, Co, Cr, Fe, Ga, Hf, In, Mg, Mn, Ni, Sb, Sc, Sn, Ta, Ti, Y, Zn, Zr, or a (e.g., any suitable) combination thereof, X may be F, Cl, Br, I, or a (e.g., any suitable) combination thereof, and 2≤a≤3). In one or more embodiments, the halide-based solid electrolyte may include, for example, Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, and/or a (e.g., any suitable) combination thereof, but embodiments of the present disclosure are not limited thereto.

### Binder

In one or more embodiments, the solid electrolyte layer may further include a binder. The binder may include the supramolecule according to one or more embodiments and may further include, for example, a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, and/or a (e.g., any suitable) combination thereof.

The binder may be included in an amount of about 0.1 wt % to about 3 wt %, for example, about 0.5 wt % to about 2 wt %, about 0.5 wt % to about 1.5 wt %, based on 100% by a total weight of the solid electrolyte layer. When the binder is included in the above range, the components in the solid electrolyte layer may be well combined without reducing the ionic conductivity of the solid electrolyte, thereby improving the durability and reliability of the battery.

### Other Components

In one or more embodiments, the solid electrolyte layer may further include an alkali metal salt, and/or an ionic liquid, and/or a conductive polymer.

The alkali metal salt may be, for example, a lithium salt. A content (e.g., amount) of the lithium salt in the solid electrolyte layer may be greater than or equal to about 1 M, for example, about 1 M to about 4 M. In these embodiments, the lithium salt may improve ionic conductivity by improving lithium ion mobility of the solid electrolyte layer.

The lithium salt may be applied without type or kind limitations, and may include, for example, LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato) borate (LiBOB), lithium difluoro (oxalato) borate (LiDFOB), lithium difluorobis(oxalato)phosphate (LiDFBP), lithium bis(trifluoromethane sulfonyl)imide (LiTFSI), lithium bis(fluoro) sulfonyl)imide (LiFSI), lithium bis(pentafluoroethanesulfonyl) imide (LiBETI), lithium trifluoromethane sulfonate, lithium tetrafluoroethane sulfonate, and/or a (e.g., any suitable) combination thereof.

In one or more embodiments, the lithium salt may be an imide-based lithium salt such as LiTFSI, LiFSI, LiBETl, or a (e.g., any suitable) combination thereof. The imide-based lithium salt may maintain or improve ionic conductivity by appropriately or suitably maintaining chemical reactivity with the ionic liquid.

The ionic liquid has a melting point below room temperature, so it is in a liquid state at room temperature and refers to a salt or a room temperature molten salt composed of ions alone.

The ionic liquid may be a compound including at least one cation selected from among a) ammonium-based cations, pyrrolidinium-based cations, pyridinium-based cations, pyrimidinium-based cations, imidazolium-based cations, piperidinium-based cations, pyrazolium-based cations, oxazolium-based cations, pyridazinium-based cations, phosphonium-based cations, sulfonium-based cations, triazolium-based cations, and/or a (e.g., any suitable) mixture thereof, and b) at least one anion selected from among BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, SO₄²⁻, CF₃SO₃⁻, (FSO₂)₂N⁻, (C₂F₅SO₂)₂N⁻, (C₂F₅SO₂) (CF₃SO₂)N⁻, and (CF₃SO₂)₂N⁻.

In one or more embodiments, the ionic liquid may be, for example, one or more selected from among N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, for example, about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, and/or the like, of the all-solid-state rechargeable battery may be improved.

The all-solid-state rechargeable battery may be a unit cell with a structure of positive electrode/solid electrolyte layer/negative electrode, a bicell with a structure of negative electrode/solid electrolyte layer/positive electrode/solid electrolyte layer/negative electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, and/or the like. Additionally, the all-solid-state rechargeable battery may also be applied to large batteries used in electric vehicles, and/or the like. For example, in one or more embodiments, the all-solid-state rechargeable battery may be used in hybrid vehicles such as plug-in hybrid electric vehicles (PHEV). In one or more embodiments, the all-solid-state rechargeable battery may be used in a field requiring a large amount of power storage, and may be used, for example, in an electric bicycle or a power tool. In one or more embodiments, the all-solid-state rechargeable battery may be used in one or more suitable fields such as portable electronic devices.

Hereinafter, examples of the present disclosure and comparative examples are described. It is to be understood, however, that the examples are for the purpose of illustration and are not to be construed as limiting the disclosure.

### Example 1

### 1. Preparation of PAA-pPD Supramolecule

5 g of a polyacrylic acid (PAA) polymer was mixed with p-phenylenediamine (pPD) in a molar ratio of 10:1 (=a monomer unit of the PAA polymer: pPD) in a water solvent, and then, stirred at 120° C. for 4 hours and adjusted to a concentration of 10 wt % in a water solvent.

### 2. Preparation of Lithium Ion-Doped PAA-pPD Supramolecule

Lithium ion-doping was performed by using a lithium-bis(trifluoromethanesulfonyl)imide (LiTFSI) salt. LiTFSI was added to the solution containing pPD cross-linked supramolecules in a molar ratio of 10:1 (=the monomer unit of the PAA polymer: LiTFSI).

### 3. Manufacturing of Half-Cell I

Silicon nanoparticles and pitch were mixed in a weight ratio of 1:1, heated at 5° C./min, and carbonized at 900° C. After the carbonization, the obtained powder was ball-milled for 20 minutes to obtain a Si—C composite.

The Si—C composite negative electrode active material, a Super-P conductor, and the prepared PAA-pPD supramolecule binder in a weight ratio of 70:15:15 were mixed in an ethanol solvent to prepare a negative electrode active material layer slurry. The negative electrode active material layer slurry was coated on a copper foil current collector, dried in a 120° C. vacuum oven, and compressed to manufacture a negative electrode.

Between the negative electrode and a lithium metal counter electrode, a microporous polypropylene (PP) film separator was interposed, and an electrolyte solution prepared by dissolving 1.3 M LiPF₆ in a mixed solvent of ethylene carbonate (EC) and dimethyl carbonate (DMC) in a volume ratio of 3:7 and adding fluoroethylene carbonate (FEC) as an additive thereto was injected thereinto to manufacture a half-cell.

### 4. Manufacturing of Half-Cell II

A half-cell was manufactured in substantially the same manner as Half-cell I except that 97.5 wt % of a negative electrode active material prepared by mixing graphite and Si—C in a weight ratio of 85.5:14.5 and 2.5 wt % of the PAA-pPD supramolecule binder were mixed in an ethanol solvent to prepare a negative electrode active material layer slurry.

### 5. Manufacturing of Lithium Ion Battery Cell (Full-Cell)

97.5 wt % of a negative electrode active material prepared by mixing graphite and Si—C in a weight ratio of 85.5:14.5 and 2.5 wt % of the prepared PAA-pPD supramolecule binder in an ethanol solvent were mixed to prepare a negative electrode active material layer slurry. The negative electrode active material layer slurry was coated on a copper foil current collector, dried in a 120° C. vacuum oven, and compressed to manufacture a negative electrode.

Additionally, 98.5 wt % of a commercially available lithium nickel cobalt aluminum (NCA) positive electrode active material, 1.0 wt % of a polyvinylidene fluoride binder, and 0.5 wt % of a carbon nanotube conductive material were mixed to prepare a positive electrode active material layer slurry, and the positive electrode active material layer slurry was coated on an aluminum foil current collector and then, dried and compressed to manufacture a positive electrode.

Between the positive electrode and the negative electrode, a microporous polypropylene (PP) film separator was interposed, and then, an electrolyte solution prepared by dissolving 1.3 M LiPF₆ in a mixed solvent of ethylene carbonate (EC) and dimethyl carbonate (DMC) in a volume ratio of 3:7 and adding fluoroethylene carbonate (FEC) thereto was injected thereinto to manufacture a rechargeable lithium battery cell.

6. Manufacturing of all-Solid-State Rechargeable Battery Cell (Half-Cell)

70 wt % of a LiFePO₄ (LFP) positive electrode active material, 15 wt % of the prepared Li⁺-doped PAA-pPD cross-linking supramolecule binder, and 15 wt % of a Super P conductive material were mixed to prepare a positive electrode composition, and the positive electrode composition was coated on an aluminum foil current collector, dried in a 120° C. vacuum oven for 6 hours, and compressed to manufacture a positive electrode.

The positive electrode was used with a lithium metal as a counter electrode and a solid electrolyte layer membrane made of the Li+-doped PAA-pPD cross-linked supramolecule to manufacture an all-solid-state rechargeable battery cell in which the positive electrode/the solid electrolyte layer/the lithium metal were stacked in order. Herein, the supramolecule may play a role of both (e.g., simultaneously) a binder and an electrolyte, and the battery cell may be called to be a binder-electrolyte-integrated all-solid-state rechargeable battery cell.

### Example 2

A supramolecule and a half-cell, a rechargeable lithium battery cell, and an all-solid-state rechargeable battery cell including the same were each manufactured in the substantially same manner as described in Example 1 except that a polymer obtained by mixing carboxymethyl cellulose (CMC) and a styrene-butadiene-rubber (SBR) in a weight ratio of 1:1.5 instead of the polyacrylic acid (PAA) polymer was used to manufacture a CMC-pPD-SBR supramolecule.

### Example 3

A supramolecules and a half-cell, a rechargeable lithium battery cell, and an all-solid-state rechargeable battery cell including the same were each manufactured in substantially the same manner as described in Example 1 except that a polyethyleneoxide (PEO) polymer instead of the polyacrylic acid (PAA) polymer and an acetonitrile solvent instead of the water were used to manufacture a PEO-pPD supramolecules.

### Comparative Example 1

A half-cell, a rechargeable lithium battery cell, and an all-solid-state rechargeable battery cell were each manufactured in substantially the same manner as described in Example 1 except that PAA was used instead of the PAA-pPD supramolecule.

### Comparative Example 2

A half-cell, a rechargeable lithium battery cell, and an all-solid-state rechargeable battery cell were each manufactured in substantially the same manner as described in Example 2 except that CMC-SBR was used instead of the CMC-pPD-SBR supramolecule.

### Comparative Example 3

A half-cell, a rechargeable lithium battery cell, and an all-solid-state rechargeable battery cell were each manufactured in substantially the same manner as described in Example 3 except that PEO was used instead of the PEO-pPD supramolecule.

### Evaluation Example 1. Activation Energy Analysis

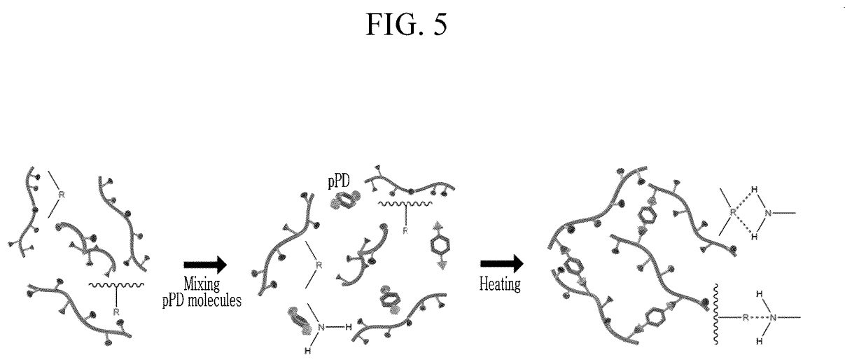

FIG. 5 is a drawing showing a process of manufacturing the supramolecule according to one or more embodiments by adding a polymer having a functional group capable of hydrogen bonding and an aromatic compound having two or more amine groups and then, performing a heat treatment. Referring to FIG. 5, when the mixture of the polymer having a functional group capable of hydrogen bonding and pPD was heated, as mobility of the polymer increased, the functional group of the polymer and the amine groups of the pPD had a hydrogen bond, forming the supramolecule with a crosslinked structure. Herein, pPD may decrease a distance between polymer chains and increase ionic conductivity.

In general, ionic conductivity of a polymer electrolyte is promoted by a dissociation reaction of lithium ions. A conventional polymer has a problem and aspect of exhibiting high activation energy for the dissociation reaction of the lithium ions and thus low lithium ionic conductivity, but if (e.g., when) pPD is introduced into the polymer, because charge transfer characteristics of pPD are introduced to the polymer, the polymer may not only maintain mobility but also improve the ionic conductivity inside molecules. In order to realize high lithium ionic conductivity, activation energy for the dissociation reaction of the lithium ions should be reduced.

In order to confirm the activation energy for the dissociation reaction of the lithium ions, PEO doped with the lithium ions was checked with respect to a transition state of ionic conduction at 298.15 K. Because PEO doped with the lithium ions, in which the lithium ions have a covalent bond with several oxygens, one of two Li—O bonds has to be cut or broken in order to conduct the lithium ions. Based on this, as a result of calculating the transition state of PEO doped with the lithium ions, ionic conduction activation energy of PEO was confirmed to be 25.1 kcal/mol.

Likewise, pPD doped with lithium ions was checked with respect to a transition state of ionic conduction. Because the lithium ions initially bind coordinately to the amine groups of pPD, in order to conduct the lithium ions, a Li—N bond must be cut or broken. Based on this, as a result of calculating a transition state of pPD doped with the lithium ions, activation energies for conducting amine-benzene and benzene-amine were respectively 5.2 and 4.8 kcal/mol.

### Evaluation Example 2: Physical Properties Analysis

### 1. Nuclear Magnetic Resonance (NMR) Analysis

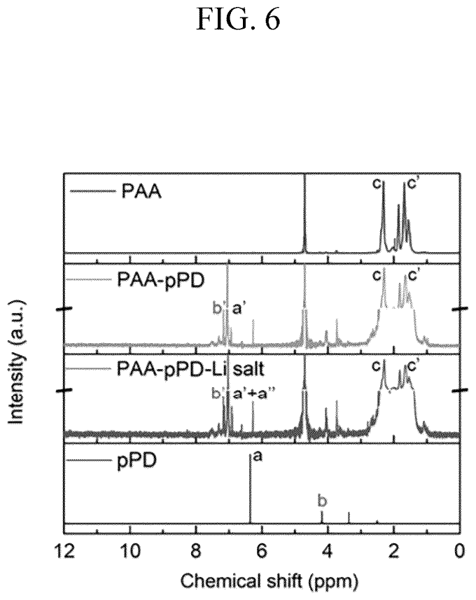

A polymer and pPD were examined with respect to a crosslinked structure through ¹H-NMR analysis. FIG. 6 show ¹H-NMR analysis graphs of PAA, PAA-pPD, PAA-pPD-Li salt, and pPD from top to bottom. Referring to FIG. 6, in the top graph showing an 1H-NMR spectrum of PAA, several peaks corresponding to C—H bonds of the polymer backbone, several peaks were observed within a range of 1 to 3 ppm, and a peak corresponding to a COOH bond was confirmed to be minimal due to deprotonation of PAA. When pPD was added to the PAA polymer (a second graph from the top), or lithium ions were introduced thereinto (a third graph from the top), a peak corresponding to an aromatic C—H bond was found at 7 ppm. In particular, as shown in the bottom graph, pPD exhibited an aromatic C—H peak at 6.3 ppm as a single peak, but pPD bound with PAA exhibited that the peak was split into several peaks, which confirmed formation of a hydrogen bond between PAA and pPD.

### 2. Fourier Transform Infrared Spectroscopy (FT-IR) Analysis

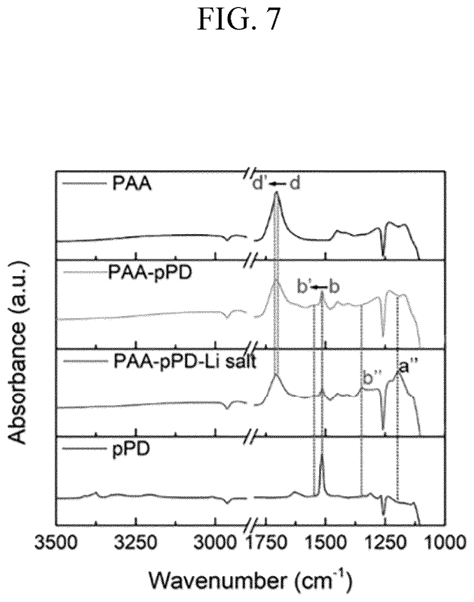

The hydrogen bond between PAA and pPD was confirmed through a FT-IR spectrum. FIG. 7 shows FT-IR analysis graphs of PAA, PAA-pPD, PAA-pPD-Li salt, and pPD from top to bottom. Referring to FIG. 7, in the bottom graph, an amine group of pPD exhibited a peak at 1514 cm⁻¹, but in the second and third graphs from the top, an amine group of PAA-pPD exhibited a wide shoulder peak at 1548 cm⁻¹, which confirmed formation of a hydrogen bond. Similarly, in the top graph, a carboxylic acid group of PAA exhibited a peak at 1703 cm⁻¹, but a carboxylic acid group of PAA-pPD exhibited a peak at 1710 cm⁻¹. PAA-pPD including a lithium salt exhibited a new peak at 1346 cm⁻¹, which corresponded to a quinoid C═N peak of pPD in an oxidized form. In other words, when the lithium salt was added to the PAA-pPD, lithium ions was doped into pPD in the PAA-pPD to extract electrons from the pPD through an oxidation reduction reaction, inducing formation of a quinoid structure, which is an oxidation stage of pPD and resultantly promoting rapid charge transfer.

### 3. X-Ray Photoelectron Spectroscopy (XPS) Analysis

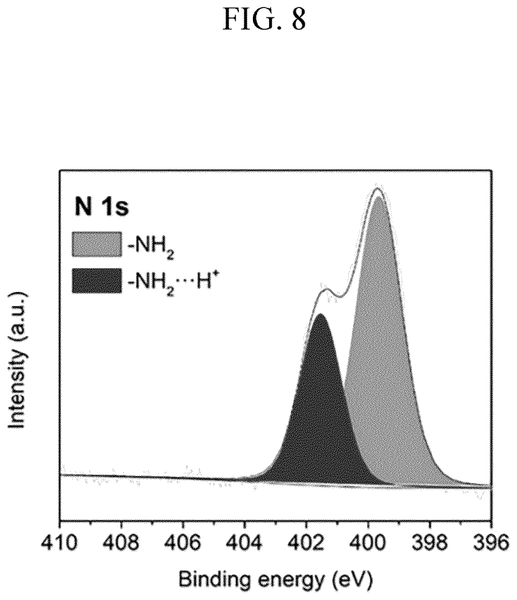

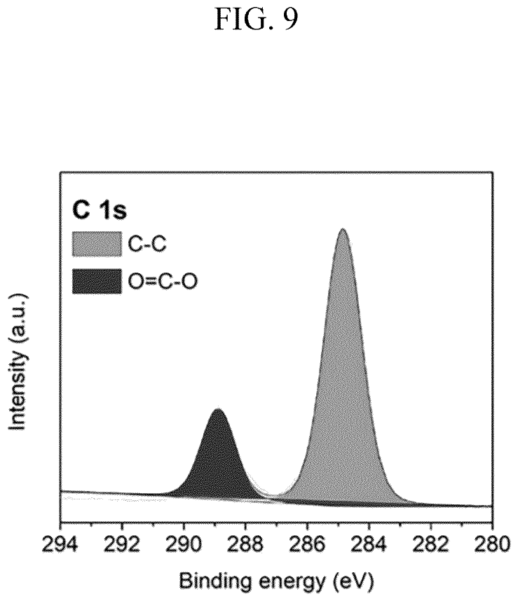

The hydrogen bond between PAA and pPD was checked through an XPS spectrum. FIG. 8 is an N 1s spectrum for PAA-pPD, and FIG. 9 is a C 1s spectrum of PAA-pPD. Referring to FIG. 8, through the N 1s spectrum, a double peak corresponding to an NH₂ bond was observed, which confirmed presence of a hydrogen bond-based network. In addition, in FIG. 9, the C 1s spectrum of PAA-pPD confirmed that there was no shared C—N bond, which confirmed no amide bond between carboxylic acid of PAA and amine group of pPD. Accordingly, it was confirmed that an acid-base reaction required for proton transfer and amidation reaction did not occur due to a small pKa difference between PAA and pPD but that PAA-pPD was formed only through a hydrogen bond.

### Evaluation Example 3: Mechanical/Rheological Characteristics Analysis

Crosslinking of a polymer and an amine group of pPD may change a molecular structure, which may induce changes in mechanical and rheological characteristics. Such characteristics may play a critical role in determining cell performance and particularly, in terms of stability of an electrode material which should maintain mechanical durability and ionic conductivity in order to maintain electrochemical activity.

### 1. Elastic Modulus Analysis

In order to evaluate an effect of a hydrogen bond of a polymer and an amine group of pPD on the mechanical characteristics, PAA-pPD was prepared as a high concentration aqueous solution (55 wt %), and rheological and mechanical characteristics of the solution were measured by using a rheometer. A storage coefficient (Storage modulus; G′) and a loss coefficient (Loss modulus; G″) were measured under constant strain (1%) and frequency sweep (0.1 rad/s to 100 rad/s) conditions and under constant frequency (1 rad/s) and strain sweep (1% to 1000%) conditions.

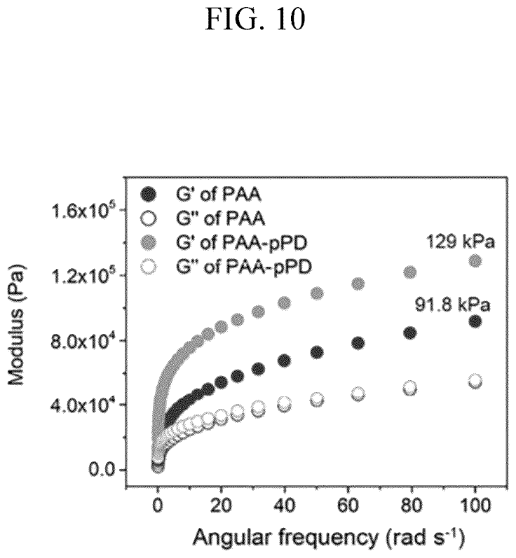

FIG. 10 is a graph analyzing a storage coefficient of PAA, a loss coefficient of PAA, a storage coefficient of PAA-pPD, and a loss coefficient of PAA-pPD to evaluate an elastic modulus. Referring to FIG. 10, in each of PAA and PAA-PPD, G′ was confirmed to be larger than G″, and as the frequency increased, G′ of PAA-pPD became larger than G′ of PAA. In particular, at a frequency of 100 rad/s, G′ of PAA-pPD was 129 kPa, which was larger by 141% than G′ of PAA, which was 91.8 kPa. PAA and PAA-pPD were respectively measured to have G″ of 54.6 and 55.8 kPa, which confirmed that elasticity characteristics of PAA-pPD were much improved. Accordingly, the PAA-pPD supramolecule had a hydrogen bond cross-linked by pPD, through which a polymer network structure was formed.

### 2. Self-Healing Characteristics Analysis

In order to check self-healing characteristics of a binder capable of withstanding damage caused by volume expansion of an active material during a lithiation process of the active material, PAA and PAA-pPD were measured with respect to G′ and G″ changes at 1 Hz (a strain of 1% to 400%, a cycle of 60 seconds).

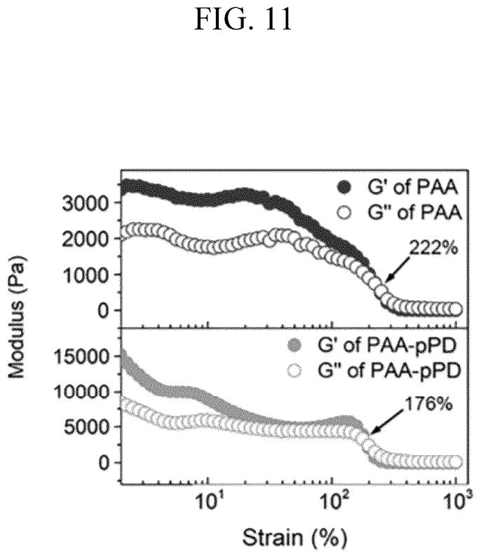

FIG. 11 is a graph analyzing the storage coefficient of PAA, the loss coefficient of PAA, the storage coefficient of PAA-pPD, and the loss coefficient of PAA-pPD to evaluate the self-healing characteristics. Referring to FIG. 11, PAA showed inversion of G′ and G″ at a strain of 222%, but PAA-pPD showed inversion of G′ and G″ at a strain of 176%. In other words, because bond strength between amine and carboxylate in PAA-pPD was weaker than carboxylic acid in PAA, the inversion of G′ and G″ in PAA-pPD shifted to a lower strain, through which PAA-pPD was confirmed to have excellent self-healing characteristics, compared with PAA. In addition, G′ (151.5 kPa) of PAA-pPD was 4.4 times larger than G′ (34.7 kPa) of PAA, which confirmed that mechanical properties were improved through a bond with pPD.

### 3. Durability Analysis

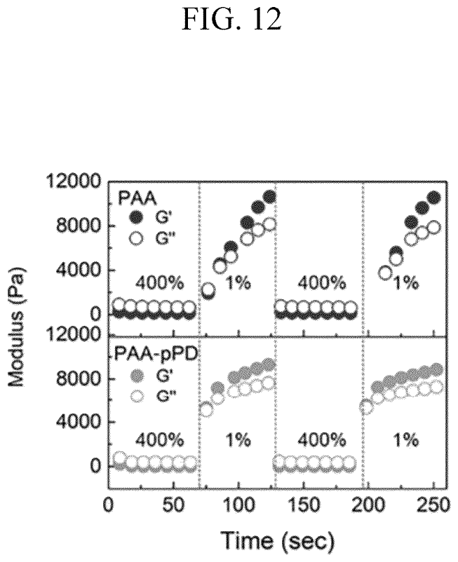

Durability was checked by measuring changes of G′ and G″, when stress was repeatedly applied thereto. Referring to FIG. 12, PAA-pPD was confirmed to exhibit superior recoverability of G′ and G″ to PAA, and accordingly, PAA-pPD exhibited better ability to maintain structural integrity and when used as a binder, exhibited better ability to accommodate expansion of an active material.

### 4. Tensile Test

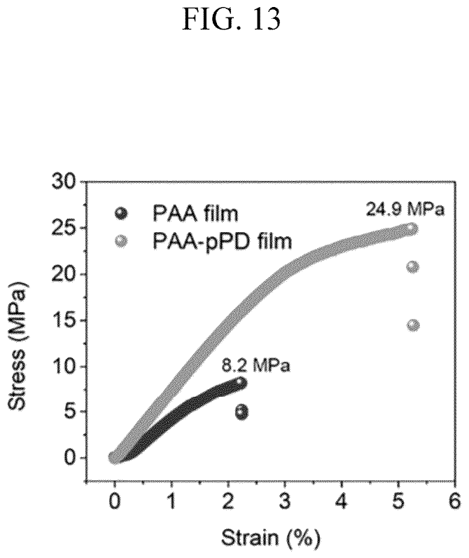

An effect of pPD on mechanical fractures of PAA and PAA-pPD was measured. A tensile test was performed by holding both (e.g., simultaneously) ends of each polymer film manufactured in a solution molding method, setting its portion where a tensile force was applied to be 10 mm, and pulling them at a constant speed of 100 mm/min. Referring to FIG. 13, the PAA film fractured, when a strain of 2.23% and an external force of 8.2 MPa were applied thereto, but the PAA-pPD film fractured, when a strain of 5.24% and an external force of 24.9 MPa were applied thereto. Accordingly, PAA-pPD was confirmed to exhibit improved mechanical strength and concurrently (e.g., simultaneously), elastomer characteristics through network formation though cross-linking by pPD.

### 5. Nano-Indentation Analysis

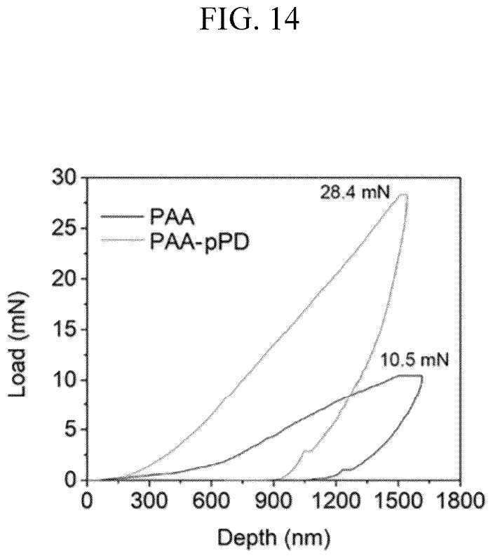

For a nano-indentation analysis, an electrode was prepared by mixing Si—C: Super P: binder in a weight ratio of 70:15:15 in ethanol and then, casting the mixture onto a copper foil with a doctor blade. Herein, the nano-indentation analysis was performed on two different cases of using PAA and PAA-pPD as a binder. After manufacturing each electrode, the electrodes were dried in a 120° C. vacuum oven and then, roll-pressed to remove pores therefrom. The electrodes were set to have a thickness of 1500 nm, and characteristics of the thin films were analyzed by using a Berkovich diamond tip (Z resolution/travel distance 0.02 μm/50 mm). Herein, each of the thin films was 10 times or more repeatedly indented at a constant speed of 0.1 mN/s under a maximum load for 5 seconds to an indentation depth set at 10% of the thin film thickness. FIG. 14 is a nano-indentation analysis graph for the electrodes to which PAA and PAA-pPD were respectively applied. Referring to FIG. 14, for the electrode including PAA, a load of 10.5 mN was measured at a depth of 1500 nm, but for the other electrode including PAA-pPD, a load of 28.4 mN was measured at the same depth. This confirmed that elastomer characteristics were achieved due to network formation through cross-linking by pPD.

### 6. Adhesion Analysis

Two types (kinds) of electrodes were manufactured in substantially the same manner as in the nano-indentation analysis, separately cut into a size of 30 mm×10 mm, and then, measured with respect to an adhesive force, after attaching a 3M tape thereto, while peeling the tape therefrom in opposite directions at a constant speed of 2 mm/min. PAA was measured to have an average adhesive force of 1.21 N, but PAA-pPD was measured to have average adhesive force of 2.32 N, which increased by 92% from that of PAA. Accordingly, the introduction of pPD for cross-linking was confirmed to improve adhesive properties due to an increase in functional groups bondable with hydrogen and also, mechanical properties through agglomeration due to the cross-linking.

### Evaluation Example 4: Ionic Conductivity Analysis

Ionic conductivity was measured through electrochemical impedance spectroscopy (EIS) by using an electrochemical station (VSP, Bio-logic). Each film was prepared by adding 10 mol % of LiTFSI salt per repeating unit of a binder polymer to each PEO, PEO-pPD, PAA, and PAA-pPD binder, stirring the mixture at 120° C. for 4 hours to obtain a uniform solution, and applying it in a drop-casting method to form a film, and then, vacuum-drying it for 6 hours. Each of the films was inserted between stainless steel spacers to manufacture symmetric cells. Each of the cells was measured with respect to electrochemical impedance at an amplitude of 10 mV within a frequency range of 100 kHz to 0.1 Hz, which was used to calculate the ionic conductivity.

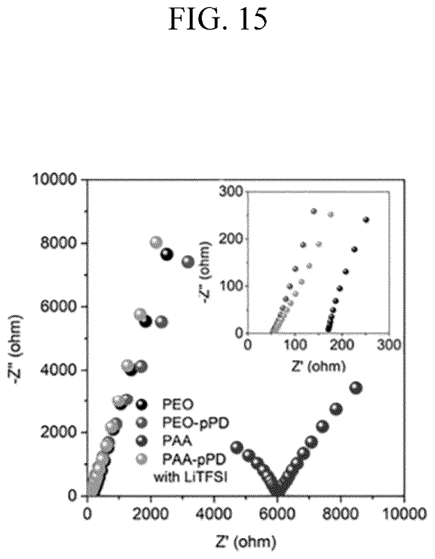

FIG. 15 shows the electrochemical impedance spectroscopy analysis results of the binders. Referring to FIG. 15, each of the PAA and PEO polymers was measured with respect to electrochemical impedance, where was respectively 6021Ω and 171Ω at a film thickness of about 200 μm. In contrast, after the pPD cross-linking, PAA-pPD and PEO-pPD respectively exhibited reduced impedance of 115Ω and 53.5Ω at a film thickness of about 400 μm.

Based on these impedance results, ionic conductivity of supramolecules, in which PAA and PEO polymers were respectively bonded with pPD, was calculated. PAA and PEO were confirmed to have ionic conductivity of 1.65×10⁻⁶ S/cm and 5.82× 10⁻⁵ S/cm, respectively. In contrast, PAA-pPD and PEO-pPD were confirmed to have ionic conductivity of 1.73×10⁻⁴ S/cm and 3.73×10⁻⁴ S/cm, respectively, which confirmed that the ionic conductivity was improved by 641% or more.

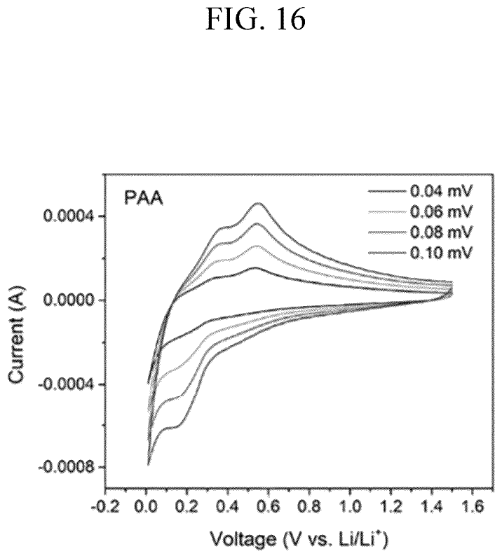

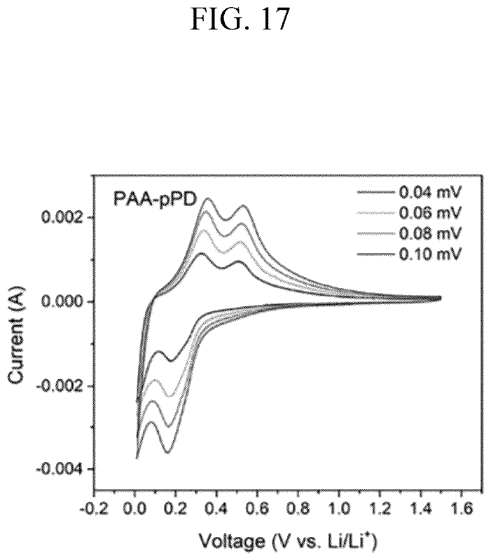

Subsequently, dielectric characteristics of lithium were checked through cyclic voltammetry (CV). FIG. 16 shows a CV graph of PAA, and FIG. 17 shows a CV graph of PAA-pPD. Referring to FIGS. 16 and 17, as a result of comparing amounts of current emitted at a specific potential by using the same electrode, the PAA-pPD supramolecule was confirmed to about 25% or more emit a current than PAA.

### Evaluation Example 5: Battery Cell Performance Analysis

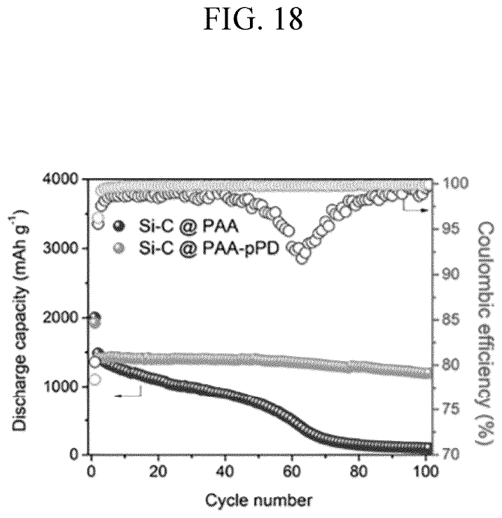

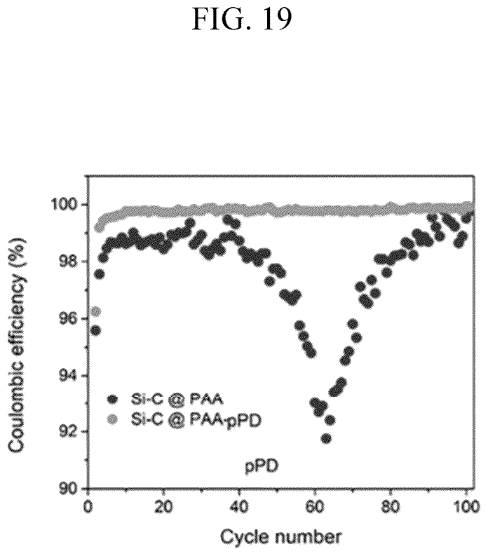

Each half-cell including the PAA binder or the PAA-pPD binder was measured with respect to cycle-life at a C-rate of 0.5 C to show a function of discharge capacity (left vertical axis) and coulombic efficiency (right vertical axis according to the number of cycles in FIG. 18. Referring to FIG. 18, discharge capacity of the half-cell of Example 1 including the PAA-pPD binder after 100 cycles maintained 84.6% (1197.5 mAh/g) of initial discharge capacity, but discharge capacity of the half-cell of Comparative Example 1 including the PAA binder maintained 6.5% (96.1 mAh/g) of initial discharge capacity. FIG. 19 is a graph enlarging only the coulombic efficiency portion in FIG. 18, and referring to FIG. 19, the half-cell including the PAA binder was measured to have average coulombic efficiency of 97.7%, but the half-cell including the PAA-pPD binder was measured to have average coulombic efficiency of 99.7%.

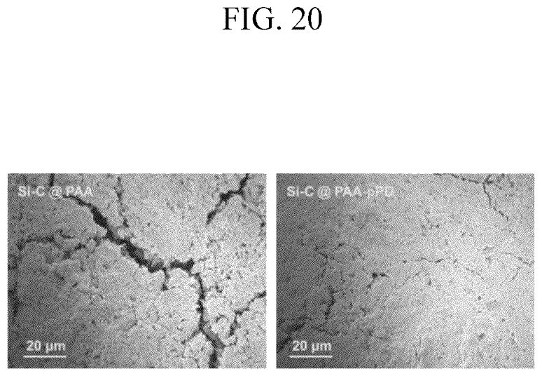

Then, each electrode including the PAA binder or the PAA-pPD binder after 100 cycles was examined with respect to a structure through SEM. At the left of FIG. 20, an SEM image of the negative electrode using the PAA binder in the half-cell according to Comparative Example 1 is shown, and at the right of FIG. 20, an image of the negative electrode using the PAA-pPD binder in the half-cell according to Example 1 is shown. Referring to FIG. 20, the electrode including the PAA-pPD binder, compared with the electrode including the PAA binder, exhibited a densely packed structure with fewer cracks, thereby confirming improved agglomeration due to pPD.

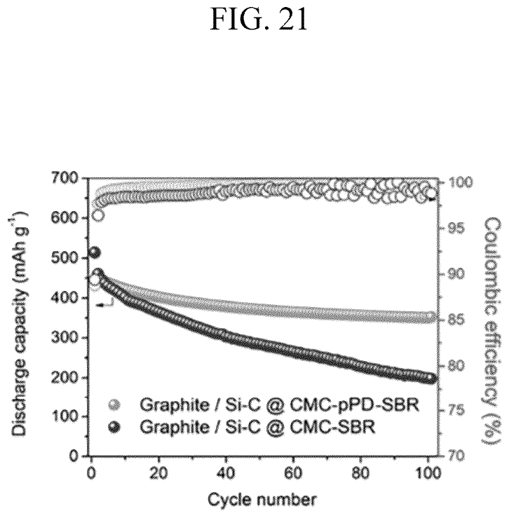

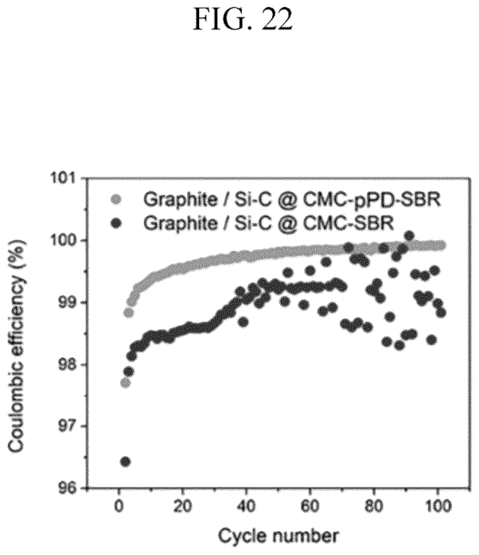

Subsequently, each half-cell including a CMC-SBR binder or a CMC-pPD-SBR binder was measured with respect to cycle-life at a C-rate of 0.5 C. FIG. 21 is graphs showing a function of discharge capacity (left vertical axis) and coulombic efficiency (right vertical axis) according to the number of cycles of Half-cell II of Example 2 using a graphite and silicon-based mixed negative electrode active material and a CMC-pPD-SBR negative electrode binder and Half-cell II of Comparative Example 2 using CMC-SBR. Referring to FIG. 21, after 100 cycles, the discharge capacity of the half-cell including the CMC-pPD-SBR binder maintained 79.7% (351.8 mAh/g) of initial discharge capacity, but the discharge capacity of the half-cell including the CMC-SBR binder maintained 44.9% (198.2 mAh/g) of initial discharge capacity. In addition, FIG. 22 is a graph enlarging the coulombic efficiency portion of FIG. 21. Referring to FIG. 22, the half-cell including the CMC-SBR binder was measured to have average coulombic efficiency of 98.9%, but the half-cell including the CMC-pPD-SBR binder was measured to have average coulombic efficiency of 99.9%.

In addition, Half-cells II of the example and the comparative example were charged and discharged within a voltage range of 2.5 V to 4.2 V at 0.1 C as the first cycle, at 0.2 C as the second cycle, and 100 cycles or more repeatedly from the third cycle within a voltage range of 2.5 V to 4.0 V at 1.0 C to evaluate cycle-life characteristics.

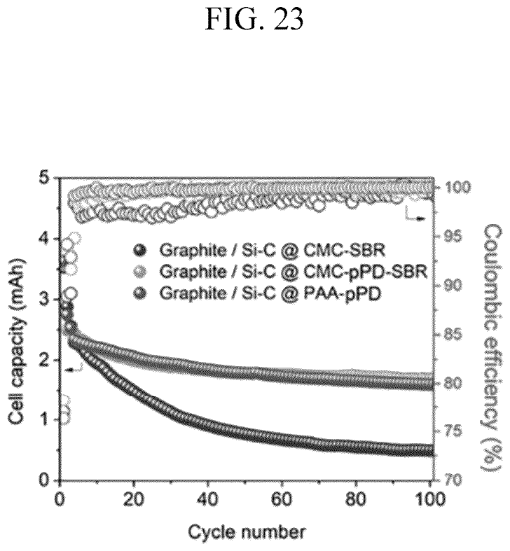

FIG. 23 is a graph showing a function of discharge capacity (left vertical axis) and coulombic efficiency (right vertical axis) according to the number of cycles of Half-cells II of Examples 1 and 2 and Comparative Example 2. Referring to FIG. 23, in the coin-type or kind cells after 100 cycles, charge capacity of the cell including the CMC-SBR binder of Comparative Example 2 maintained just 21.3% (0.49 mAh) of initial charge capacity and thus exhibited sharply deteriorated capacity. In contrast, charge capacity of the cell including the CMC-pPD-SBR binder of Example 2 maintained 73.9% (1.70 mAh) of initial charge capacity, while charge capacity of the cell including the PAA-pPD binder of Example 1 battery maintained 69.1% (1.59 mAh) of initial charge capacity, which showed less deteriorated capacity than that of the comparative example.

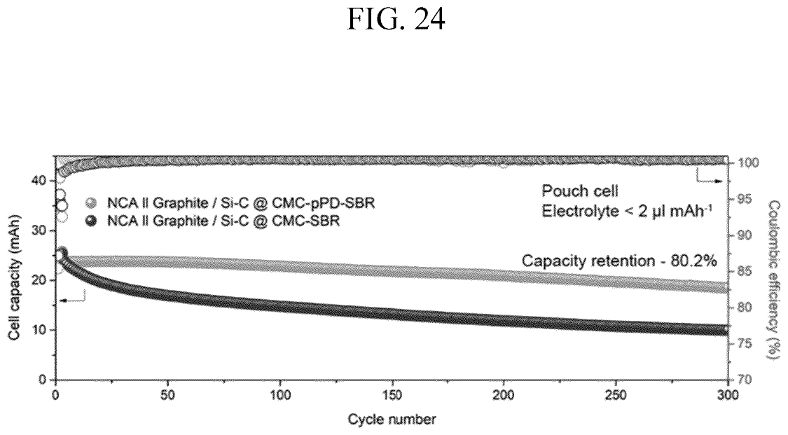

FIG. 24 is a graph showing a function of discharge capacity (left vertical axis) and coulombic efficiency (right vertical axis) according to the number of cycles as a result of evaluating cycle-life characteristics of the lithium ion battery full-cells of Example 2 and Comparative Example 2. Referring to FIG. 24, in the pouch-type or kind cells after 300 cycles, charge capacity of the cell including the CMC-SBR binder of Comparative Example 2 maintained 43.3% (9.99 mAh) of initial charge capacity and thus exhibited sharply deteriorated capacity. In contrast, charge capacity of the cell including the CMC-pPD-SBR binder of Example 2 maintained 80.2% (18.5 mAh) of initial charge capacity and thus exhibited less deteriorated capacity than that of the comparative example. Accordingly, the electrode including the CMC-pPD-SBR binder effectively interacted with lithium ions due to ionic conductivity of the binder, but the electrode including the CMC-SBR binder had no smooth reaction due to high electrochemical impedance.

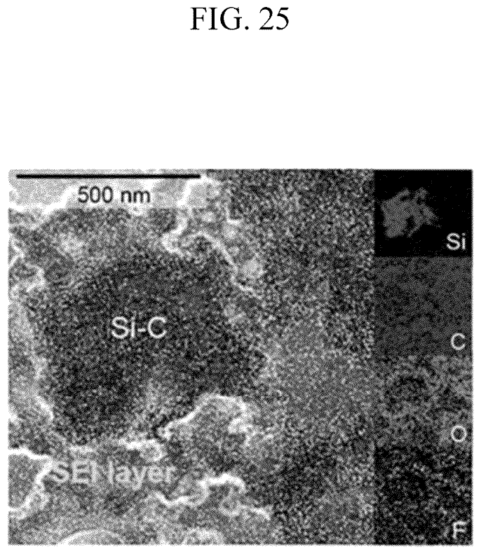

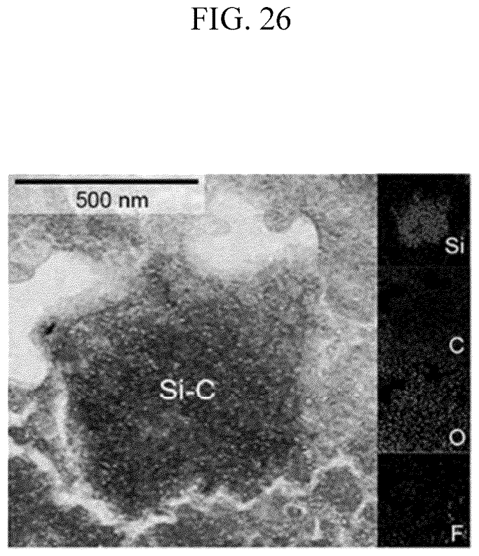

Subsequently, in order to check an effect of pPD on electrochemical stability, for Half-cells I of Example 1 and Comparative Example 1, after 100 cycles, a cross-section of each negative electrode cut by focus ion beam (FIB) was examined by using a transmission electron microscope (TEM) and an energy dispersive spectrometer (EDS). FIG. 25 is a TEM-EDS image on the cross-section of the negative electrode of Comparative Example 1, and FIG. 26 is a TEM-EDS image on the cross-section of the negative electrode of Example 1. Referring to FIG. 25, in the electrode including the PAA binder of Comparative Example 1, strong oxygen signals around Si—C particles were observed, which confirmed presence of an SEI component such as Li₂CO₃, and fluorine signals confirmed presence of another SEI component such as LiF. In contrast, referring to FIG. 26, in the electrode including the PAA-pPD binder of Example 1, almost no oxygen and fluorine signals around Si—C particles were observed, which confirmed that growth of SEI was alleviated by pPD.

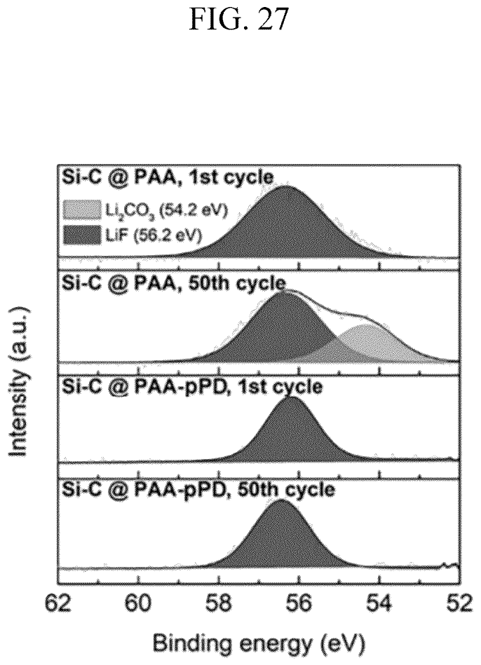

Next, after the first cycle and 50 cycles of each of Half-cells I of Example 1 and Comparative Example 1, chemical changes of each of the electrodes were examined by using XPS, and FIG. 27 shows XPS graphs of portions corresponding to binding energy of Li₂CO₃ and LiF. Referring to FIG. 27, after the initial charge and discharge cycle, a LiF bond alone was confirmed in all the electrodes including the PAA and PAA-pPD binders. However, after the 50 cycles, the electrode including the PAA binder alone exhibited a strong Li₂CO₃ peak at 54.2 eV, but the electrode including the PAA-pPD binder exhibited no peak corresponding to Li₂CO₃. This means that the example exhibited that growth of SEI containing Li₂CO₃ was alleviated by pPD as in the above TEM-EDS analysis result.

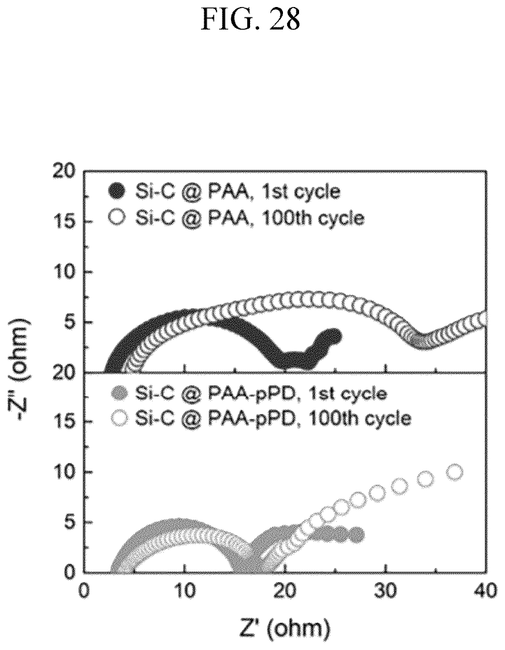

In addition, the EIS analysis results were also consistent with the XPS analysis results. FIG. 28 is a graph showing the EIS analysis results of the negative electrodes of Half-cells I of Example 1 and Comparative Example 1 after first cycle and 100 cycles. Referring to FIG. 28, the electrode including the PAA binder of Comparative Example 1 exhibited impedance of 33.8Ω after the 100 cycles, which increased by 71.6% from the impedance at the first cycle. In contrast, the electrode including the PAA-pPD binder of Example 1 exhibited impedance of 17.9Ω after the 100 cycles, which 14% increased from the impedance after the first cycle. Accordingly, electrode plate resistance characteristics of the example were confirmed to be much improved.

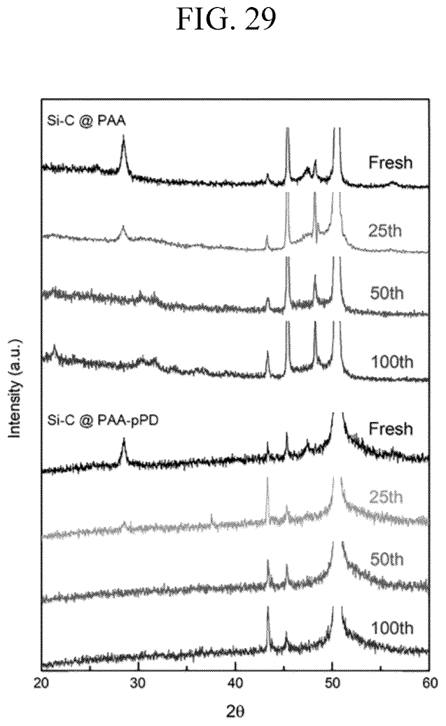

In general, SEI has a crystal structure, and because a crystal size increases over cycles, electrodes including PAA binder or PAA-pPD binder each were compared with respect to crystal growth trends. FIG. 29 is an XRD analysis graph showing crystal structure changes of negative electrode plates over the cycles such as first cycle, 25 cycles, 50 cycles, and 100 cycles in Half-cells I of Example 1 and Comparative Example 1. Referring to FIG. 29, the electrode including the PAA binder exhibited a new peak, as the number of cycles increased and in particular, peaks corresponding to 21.3°, 30.5°, 31.8°, and 33.8°, which increased, as the number of cycles increased, confirming that the PAA binder related to a Li₂CO₃ crystal structure. In contrast, in the electrode including the PAA-pPD binder, the peaks minimally appeared.

### Evaluation Example 6: All-solid-state Battery Cell Performance Analysis

If a polymer has excellent or suitable characteristics in terms of ionic conductivity and an adhesive force as well as a high elasticity coefficient, a binder and an electrolyte may be combined into a single polymer in an all-solid-state battery. Accordingly, the all-solid-state battery cell may have no contact problem between the electrolyte and an electrode material but advantages of maximizing or increasing an interface contact and uniformly (e.g., substantially uniformly) adjusting a lithium concentration inside the cell. In order to evaluate efficiency of the all-solid-state battery cell, a capacity decrease trend of LifePO₄ was measured by using a LiFePO₄ positive electrode and a lithium metal negative electrode.

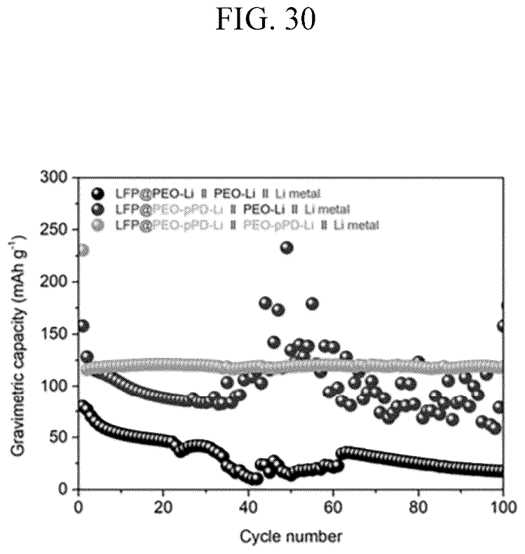

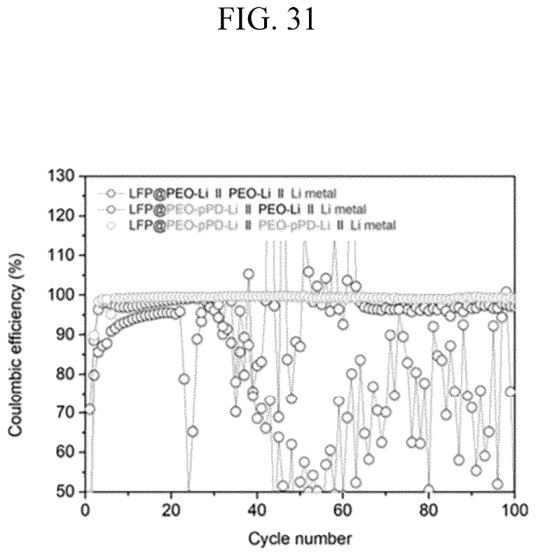

The all-solid-state battery cells of Example 3 and Comparative Example 3 and the all-solid-state battery cell of Reference Example 1, in which PEO-pPD-Li was applied to a positive electrode, and PEO-Li was applied to a solid electrolyte layer, were initially charged and discharged at 0.1 C and then, 100 times or more charged and discharged at 0.5 C. Then, FIG. 30 shows capacity graphs according to the number of cycles, and FIG. 31 shows coulombic efficiency graphs according to the number of cycles. Referring to FIG. 30, when PEO was used as a binder and an electrolyte, unstable capacity was observed. However, when PEO-pPD was used as a binder of a positive electrode, excellent capacity of 157 mAh/g at the first cycle was achieved but not stably maintained due to capacity changes by a short circuit. In contrast, when PEO-pPD was used as both (e.g., simultaneously) a binder and an electrolyte, excellent initial capacity was secured and stably maintained as well as minimally, which was confirmed by maintaining 98.7% of capacity even after the 100 cycles.

In addition, as a result of analyzing the coulombic efficiency data, referring to FIG. 31, compared with the case of using PEO as a binder and an electrolyte and the case of using PEO-pPD as a binder, the case of using PEO-pPD as both (e.g., simultaneously) of the binder and the electrolyte exhibited 99.7% of coulombic efficiency on average, which confirmed stable operation of the cell.

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, or 5% of the stated value.

In the context of the present disclosure and unless otherwise defined, the terms “use,” “using,” and “used” may be considered synonymous with the terms “utilize,” “utilizing,” and “utilized,” respectively.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery (e.g., an electrode active material and/or electrolyte) manufacturing device, a battery management system (BMS) device, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While this disclosure has been described in connection with what is presently considered to be example embodiments, it is to be understood that the present disclosure is not limited to the disclosed embodiments. In contrast, it is intended to cover one or more suitable modifications and equivalent arrangements included within the spirit and scope of the appended claims and equivalents thereof.

### REFERENCE NUMERALS

100: rechargeable lithium battery
10: positive electrode
11: positive electrode lead tab
12: positive terminal
20: negative electrode
21: negative electrode lead tab
22: negative terminal
30: separator
40: electrode assembly
50: case
60: sealing member
70: electrode tab
71: positive electrode tab
72: negative electrode tab

What is claimed is:

1. A supramolecule, comprising
a polymer comprising a functional group capable of hydrogen bonding; and
an aromatic compound comprising two or more amine groups,
wherein the functional group capable of hydrogen bonding of the polymer and the amine group of the aromatic compound form a hydrogen bond.

2. The supramolecule as claimed in claim 1, wherein
the functional group capable of hydrogen bonding is a functional group comprising at least one selected from among oxygen and nitrogen.

3. The supramolecule as claimed in claim 1, wherein
the functional group capable of hydrogen bonding is one or more selected from among a carboxyl group, a carbonate group, a hydroxyl group, an ether group, an ester group, a carbonyl group, and an amine group.

4. The supramolecule as claimed in claim 1, wherein
the polymer comprising the functional group capable of hydrogen bonding comprises polyacrylic acid, polyethyleneoxide, carboxymethyl cellulose, polyvinyl alcohol, polyacrylamide, poly N-(2-hydroxypropyl) methacrylamide, polyethyleneimine, polymethylmethacrylate, polymethylacrylate, polyvinylacetate, polyethylene glycol, polypropyleneoxide, polycarbonate, polyacrylamide, or a combination thereof.

5. The supramolecule as claimed in claim 1, wherein
when the aromatic compound has two amine groups, each of the amine groups is substituted, relative to each other, at a para position of the aromatic compound.

6. The supramolecule as claimed in claim 1, wherein
the aromatic compound comprising two or more amine groups is paraphenylenediamine.

7. The supramolecule as claimed in claim 1, wherein
the supramolecule further comprises a lithium ion.

8. The supramolecule as claimed in claim 1, wherein
an activation energy of a reaction in which lithium ions are conducted in the aromatic compound comprising two or more amine groups is less than or equal to about 10 kcal/mol.

9. The supramolecule as claimed in claim 1, wherein
the supramolecule has an ionic conductivity of greater than or equal to about 1×10⁻⁴ S/cm according to electrochemical impedance spectroscopy.

10. The supramolecule as claimed in claim 1, wherein
the supramolecule is utilized as a binder and a solid electrolyte for a rechargeable lithium battery.

11. A rechargeable lithium battery comprising the supramolecule as claimed in claim 1.

12. A rechargeable lithium battery, comprising:
a positive electrode;
a negative electrode;
a separator between the positive electrode and the negative electrode; and
an electrolyte,
wherein at least one of the positive electrode, the negative electrode, the separator, or the electrolyte comprises the supramolecule as claimed in claim 1.

13. The rechargeable lithium battery as claimed in claim 12, wherein
the negative electrode comprises a silicon-based negative electrode active material and the supramolecule.

14. The rechargeable lithium battery as claimed in claim 12, wherein
the negative electrode comprises a silicon-based negative electrode active material, a graphite-based negative electrode active material, and the supramolecule.

15. An all-solid-state rechargeable battery, comprising:
a positive electrode;
a negative electrode; and
a solid electrolyte layer between the positive electrode and the negative electrode,
wherein at least one of the positive electrode, the negative electrode, or the solid electrolyte layer comprises the supramolecule as claimed in claim 1.

16. The all-solid-state rechargeable battery as claimed in claim 15, wherein,
the positive electrode comprises a positive electrode active material, and the supramolecule.

17. The all-solid-state rechargeable battery as claimed in claim 15, wherein,
the solid electrolyte layer comprises the supramolecule.

18. The all-solid-state rechargeable battery as claimed in claim 15, wherein,
the positive electrode comprises a positive electrode active material and the supramolecule, and
the solid electrolyte layer comprises the supramolecule.
